(19) United States
(12) Patent Application Publication
(10) Pub. No.: US 2023/0397080 A1
(43) Pub. Date: Dec. 7, 2023

(54) Methods and Apparatuses for Providing Handover Related Information

(71) Applicant: Telefonaktiebolaget LM Ericsson (publ), Stockholm (SE)

(72) Inventors: Ali Parichehrehteroujeni, Linköping (SE); Pradeepa Ramachandra, Linköping (SE); Sakib Bin Redhwan, Linköping (SE)

(21) Appl. No.: 18/032,946

(22) PCT Filed: Sep. 16, 2021
(86) PCT No.: PCT/SE2021/050887

§ 371 Date: Apr. 20, 2023

Related U.S. Application Data
(60) Provisional application No. 63/104,130, filed on Oct. 22, 2020.

(51) Int. Cl. H04W 36/30; H04W 36/36

(52) U.S. Cl. CPC H04W 36/305; H04W 36/362

(57) ABSTRACT

Embodiments described herein relate to methods and apparatus for providing handover related information. A method performed by a wireless device for reporting handover related information to a base station for mobility parameter optimization comprises: responsive to detection of a radio link failure or a Secondary Cell Group, SCG, failure after a successful handover, transmitting an indication of a handover type of the successful handover to the base station. A method performed by abase station for receiving handover related information for mobility parameter optimization comprises: responsive to a radio link failure or a Secondary Cell Group, SCG, failure occurring after a successful handover of a wireless device, receiving an indication of a handover type of the successful handover.

### TECHNICAL FIELD

Embodiments of the present disclosure relate to methods and apparatuses in networks, and particularly methods, wireless devices and base stations for providing handover related information.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

### RLF Report

For a wireless device in a connected mode, the network typically configures the wireless device to perform and report Radio Resource Management (RRM) measurements to assist network-controlled mobility decisions (i.e. handovers, where the network decides to hand over the UE from one cell to another).

As a fallback, in case handovers do not work properly, a failure detection and wireless device autonomous counter-action has been specified, the co-called Radio Link Failure (RLF) handling (described further below). That RLF procedure is typically triggered when something unexpected happens (e.g. a radio link failure) in any of the mobility related procedures (described in more detail below).

The radio link failure may be detected internally at the wireless device due to some interactions between the Radio Resource Control (RRC) and lower layer protocols such as L1, Medium Access Control (MAC), Radio Link Control (RLC), etc. In the case of L1, a procedure called radio link monitoring has been introduced.

Different events may trigger the RLF procedure and the content of RLF reports, to support Mobility Robustness Optimization (MRO). Among different events that may trigger RLF in Long Term Evolution (LTE) and New Radio (NR), are the following two non-limiting options:
A RLF due to radio link problem (for example, the expiry of timer T301) i.e. RLF due to problems indicated by physical layer;
A RLF due to random access problem, i.e., RLF indicated by MAC layer;

RLF triggered by other reasons (e.g. RLC) may (in some examples) not be considered for embodiments described herein.

In LTE, lower layers provide to upper layers the indications Out-of-Sync (OOS) and In-Sync (IS), internally by the User Equipment's (UE's) physical layer, which in turn may apply Radio Resource Control (RRC)/layer 3 (i.e. higher layer) filtering for the evaluation of Radio Link Failure (RLF). The procedure is illustrated in FIG. 1.

The details of the wireless device actions related to RLF are captured in the RRC specifications, in particular TS 36.331 v16.2.1, an extract of which is repeated below.

Extract from TS 36.331 v16.2.1

5.2.2.9 Actions upon reception of SystemInformationBlockType2

Upon receiving SystemInformationBlockType2, the UE shall:
1> apply the configuration included in the radioResourceConfigCommon;

. . .
1> if in RRC_CONNECTED and UE is configured with RLF timers and constants values received within rlf-TimersAndConstants:
   2> not update its values of the timers and constants in ue-TimersAndConstants except for the value of timer T300;

. . .

5.3.10.0 General

The UE shall:
1> if the received radioResourceConfigDedicated includes the rlf-TimersAndConstants:
   2> reconfigure the values of timers and constants as specified in 5.3.10.7;

. . .

5.3.10.7 Radio Link Failure Timers and Constants Reconfiguration

The UE shall:
1> if the received rlf-TimersAndConstants is set to release:
   2> use values for timers T301, T310, T311 and constants N310, N311, as included in ue-TimersAndConstants received in SystemInformationBlockType2 (or SystemInformationBlockType2-NB in NB-IoT);
1> else:
   2> reconfigure the value of timers and constants in accordance with received rlf-TimersAndConstants;
1> if the received rlf-TimersAndConstantsSCG is set to release:
   2> stop timer T313, if running, and
   2> release the value of timer t313 as well as constants n313 and n314;
1> else:
   2> reconfigure the value of timers and constants in accordance with received rlf-TimersAndConstantsSCG;

[ . . . ]

5.3.10.11 SCG Dedicated Resource Configuration

The UE shall:
. . .
1> if the received radioResourceConfigDedicatedSCG includes the rlf-TimersAndConstantsSCG:
   2> reconfigure the values of timers and constants as specified in 5.3.10.7;

. . .

5.3.11.1 Detection of Physical Layer Problems in RRC_CONNECTED

The UE shall:
1> upon receiving N310 consecutive “out-of-sync” indications for the PCell from lower layers while neither T300, T301, T304 nor T311 is running:
   2> start timer T310;
1> upon receiving N313 consecutive “out-of-sync” indications for the PSCell from lower layers while T307 is not running:
   2> start T313;
      NOTE: Physical layer monitoring and related autonomous actions do not apply to SCells except for the PSCell.

5.3.11.2 Recovery of Physical Layer Problems

Upon receiving N311 consecutive “in-sync” indications for the PCell from lower layers while T310 is running, the UE shall:
1> stop timer T310;
1> stop timer T312, if running;
   NOTE 1: In this case, the UE maintains the RRC connection without explicit signalling, i.e. the UE maintains the entire radio resource configuration.
   NOTE 2: Periods in time where neither “in-sync” nor “out-of-sync” is reported by layer 1 do not affect the evaluation of the number of consecutive “in-sync” or “out-of-sync” indications.

Upon receiving N314 consecutive “in-sync” indications for the PSCell from lower layers while T313 is running, the UE shall:
1> stop timer T313;

RLF-TimersAndConstants

The IE RLF-TimersAndConstants contains UE specific timers and constants applicable for UEs in RRC_CONNECTED.

RLF-TimersAndConstants information element

| | |
|---|---|
| -- ASN1START | |
| RLF-TimersAndConstants-r9 ::= | CHOICE { |
| release | NULL, |
| setup | SEQUENCE { |
| t301-r9 | ENUMERATED { |
| | ms100, ms200, ms300, ms400, |
| ms600, ms1000, ms1500, | |
| | ms2000}, |
| t310-r9 | ENUMERATED { |
| | ms0, ms50, ms100, ms200, |
| ms500, ms1000, ms2000}, | |
| n310-r9 | ENUMERATED { |
| | n1, n2, n3, n4, n6, n8, |
| n10, n20}, | |
| t311-r9 | ENUMERATED { |
| | ms1000, ms3000, ms5000, |
| ms10000, ms15000, | |
| | ms20000, ms30000}, |
| n311-r9 | ENUMERATED { |
| | n1, n2, n3, n4, n5, n6, n8, |
| n10}, | |
| ... | |
| } | |
| } | |
| RLF-TimersAndConstants-r13 ::= | CHOICE { |
| release | NULL, |
| setup | SEQUENCE { |
| t301-v1310 | ENUMERATED { |
| | ms2500, ms3000, ms3500, |
| ms4000, ms5000, | |
| | ms6000, ms8000, |
| ms10000}, | |
| ..., | |
| [[ t310-v1330 | ENUMERATED {ms4000, |
| ms6000} OPTIONAL -- Need ON | |
| ]] | |
| } | |
| } | |

RLF-TimersAndConstantsSCG-r12 ::= CHOICE {

| | |
|---|---|
| release | NULL, |
| setup | SEQUENCE { |
| t313-r12 | ENUMERATED { |
| | ms0, ms50, ms100, ms200, |
| ms500, ms1000, ms2000}, | |
| n313-r12 | ENUMERATED { |
| | n1, n2, n3, n4, n6, n8, |
| n10, n20}, | |
| n314-r12 | ENUMERATED { |
| | n1, n2, n3, n4, n5, n6, n8, |
| n10}, | |
| ... | |
| } | |
| } | |
| -- ASN1STOP | |

RLF-TimersAndConstants field descriptions

n3xy
Constants are described in section 7.4. n1 corresponds with 1, n2 corresponds with 2 and
so on.
t3xy
Timers are described in section 7.3. Value ms0 corresponds with 0 ms, ms50 corresponds
with 50 ms and so on.
E-UTRAN configures RLF-TimersAndConstants-r13 only if UE supports ce-ModeB. UE
shall use the extended values t3xy-v1310 and t3xy-v1330, if present, and ignore the
values signaled by t3xy-r9.

Timers (Informative)

| Timer | Start | Stop | At expiry |
|---|---|---|---|
| T301 | Transmission of | Reception of | Go to RRC_IDLE |
| NOTE1 | RRCConnectionReestabilshmentRequest | RRCConnectionReestablishment | |
| | | or | |
| | | RRCConnectionReestablishmentReject | |
| | | message as well as when the | |
| | | selected cell becomes unsuitable | |
| T310 | Upon detecting physical | Upon receiving N311 consecutive | If security is not activated: |
| NOTE1 | layer problems for the | in-sync indications from lower | go to RRC_IDLE else: initiate |
| NOTE2 | PCell i.e. upon receiving | layers for the PCell, upon | the connection re-establishment |
| | N310 consecutive out-of- | triggering the handover procedure | procedure |
| | sync indications from | and upon initiating the connection | |
| | lower layers | re-establishment procedure | |
| T311 | Upon initiating the RRC | Selection of a suitable E-UTRA | Enter RRC_IDLE |
| NOTE1 | connection re-establishment | cell or a cell using another RAT. | |
| | procedure | | |
| T313 | Upon detecting physical layer | Upon receiving N314 consecutive | Inform E-UTRAN about the |
| NOTE2 | problems for the PSCell i.e. | in-sync indications from lower | SCG radio link failure by |
| | upon receiving N313 consecutive | layers for the PSCell, upon | initiating the SCG failure |
| | out-of-sync indications from | initiating the connection re- | information procedure as |
| | lower layers | establishment procedure, upon | specified in 5.6.13. |
| | | SCG release and upon receiving | |
| | | RRCConnectionReconfiguration | |
| | | including MobilityControlInfoSCG | |

NOTE1:
Only the timers marked with “NOTE1” are applicable to NB-IoT.
NOTE2:
The behaviour as specified in 7.3.2 applies

| Constant | Usage |
|---|---|
| N310 | Maximum number of consecutive “out-of-sync” indications |
| | for the PCell received from lower layers |
| N311 | Maximum number of consecutive “in-sync” indications for |
| | the PCell received from lower layers |
| N313 | Maximum number of consecutive “out-of-sync” indications |
| | for the PSCell received from lower layers |
| N314 | Maximum number of consecutive “in-sync” indications for |
| | the PSCell received from lower layers |

Mobility Robustness Optimization (MRO) in RLF Report

Seamless handovers are a key feature of 3GPP technologies. Successful handovers ensure that the UE (or wireless device) moves around in the coverage area of different cells without causing interruptions in the data transmission. However, there will be scenarios when the network fails to handover the wireless device to the ‘correct’ neighbor cell in time and in such scenarios the wireless device may declare the radio link failure (RLF), either before it sends a measurement report in source, before receiving a handover command, quickly after it executes a successful handover to a target cell or a Handover Failure (HOF), e.g., upon expiry of timer T304, started when the UE starts the synchronization with the target cell.

Upon HOF and RLF, the UE may take autonomous actions, for example, trying to select a cell and initiate reestablishment procedure so that the UE is reachable again as soon as possible. The RLF will cause a poor user experience as the RLF is declared by the UE only when it realizes that there is no reliable communication channel (radio link) available between itself and the network. Also, reestablishing the connection requires signaling with the newly selected cell (e.g. random access procedure, RRC Reestablishment Request, RRC Reestablishment RRC Reestablishment Complete, RRC Reconfiguration and RRC Reconfiguration Complete) and adds some latency, until the UE can exchange data with the network again.

Since Rel-16, MRO use cases regarding the different failure scenarios during mobility procedures have been defined. One of the functions of MRO is to detect connection failures that occur due to handovers that occur too early (Too Early Handovers); handovers that occur too late (Too Late Handovers), or handovers to the wrong cell (Handover to Wrong Cell). These problems are defined as follows:

For an Intra-system Too Late Handover an RLF may occur after the wireless device has remained for a long period of time in the cell, and the UE attempts to re-establish the radio link connection in a different cell.
For an Intra-system Too Early Handover, an RLF may occur shortly after a successful handover from a source cell to a target cell or a handover failure may occur during the handover procedure; the wireless device then attempts to re-establish the radio link connection in the source cell.
For an Intra-system Handover to Wrong Cell, an RLF may occur shortly after a successful handover from a source cell to a target cell or a handover failure may occur during the handover procedure; the wireless device then attempts to re-establish the radio link connection in a cell other than the source cell and the target cell.
In the definitions above, the “successful handover” refers to the UE state, namely the successful completion of the RA procedure.

Causes for RLF and HOF

According to the specifications (e.g. TS 36.331 v16.2.1), the possible causes for a radio link failure (RLF) could be one of the following:
1) Expiry of the radio link monitoring related timer T310;
2) Expiry of the measurement reporting associated timer T312 (not receiving the handover command from the network within this timer's duration despite sending the measurement report when T310 was running);
3) Upon reaching the maximum number of RLC retransmissions;
4) Upon receiving random access problem indication from the MAC entity;

As RLF leads to reestablishment which degrades performance and user experience, it is in the interest of the network to understand the reasons for the RLF, and try to optimize mobility related parameters (e.g. trigger conditions of measurement reports) to avoid later RLFs. Before the standardization of MRO related report handling in the network, only the wireless device was aware of some information associated with the radio quality at the time of RLF, for example, the actual reason for declaring RLF etc. For the network to identify the reason for the RLF, the network requires further information, both from the wireless device and also from the neighboring base stations.

As part of the MRO solution in NR, the RLF reporting procedure was introduced in the RRC specification in Rel-16 RAN2 work. That has impacted the RRC specifications (TS 38.331) in the sense that it was standardized that the wireless device would log relevant information at the moment of an RLF, and would later report the information to a target cell that the wireless device succeeds to connect to (e.g. after re-establishment). This standardisation has also impacted the inter-gNodeB interface, i.e., XnAP specifications (TS 38.423), as a gNodeB receiving an RLF report may forward the RLF report to the gNodeB where the failure occurred.

For the RLF report generated by the UE, the contents of the RLF report have been enhanced with more details in the subsequent releases. The measurements included in the RLF measurement report based on the latest New Radio (NR) Radio Resource Control (RRC) specification TS 38.331 v16.2.0 are:
1) Measurement quantities (RSRP, RSRQ) of the last serving cell (PCell).
2) Measurement quantities of the neighbor cells in different frequencies of different RATs (NR, EUTRA, UTRA, GERAN, CDMA2000).
3) RACH information
4) Reestablishment cell ID
5) Reconnect cell ID
6) Measurement quantity (RSSI) associated to WLAN Aps.
7) Measurement quantity (RSSI) associated to Bluetooth beacons.
8) Location information, if available (including location coordinates and velocity)
9) Globally unique identity of the last serving cell, if available, otherwise the PCI and the carrier frequency of the last serving cell.
10) Tracking area code of the PCell.
11) Time elapsed since the last reception of the ‘Handover command’ message.
12) Time elapsed since failure
13) C-RNTI used in the previous serving cell.
14) Whether or not the wireless device was configured with a DRB having QCI value of 1.

The detection and logging of the RLF related parameters is captured in the following extract of the NR RRC specification.

Extract from TS 38.331 v16.2.0

The UE shall:
1> if any DAPS bearer is configured:
   2> upon T310 expiry in source SpCell; or
   2> upon random access problem indication from source MCG MAC; or
   2> upon indication from source MCG RLC that the maximum number of retransmissions has been reached; or
   2> upon consistent uplink LBT failure indication from source MCG MAC:
      3> consider radio link failure to be detected for the source MCG i.e. source RLF;
      3> suspend the transmission of all DRBs in the source MCG;
      3> reset MAC for the source MCG;
      3> release the source connection.
1> else:
   2> upon T310 expiry in PCell; or
   2> upon T312 expiry in PCell; or
   2> upon random access problem indication from MCG MAC while neither T300, T301, T304, T311 nor T319 are running; or
   2> upon indication from MCG RLC that the maximum number of retransmissions has been reached; or
   2> if connected as an IAB-node, upon BH RLF indication received on BAP entity from the MCG; or
   2> upon consistent uplink LBT failure indication from MCG MAC while T304 is not running:
      3> if the indication is from MCG RLC and CA duplication is configured and activated, and for the corresponding logical channel allowedServingCells only includes SCell(s):
         4> initiate the failure information procedure as specified in 5.7.5 to report RLC failure.
      3> else:
         4> consider radio link failure to be detected for the MCG i.e. RLF;
         4> discard any segments of segmented RRC messages stored according to 5.7.6.3;
         4> store the following radio link failure information in the VarRLF-Report by setting its fields as follows:
         5> clear the information included in VarRLF-Report, if any;
         5> set the plmn-IdentityList to include the list of EPLMNs stored by the UE (i.e. includes the RPLMN);
         5> set the measResultLastServCell to include the RSRP, RSRQ and the available SINR, of the source PCell based on the available SSB and CSI-RS measurements collected up to the moment the UE detected radio link failure;
         5> set the ssbRLIVIConfigBitmap and/or csi-rsRLIVIConfigBitmap in measResultLastServCell to include the radio link monitoring configuration of the source PCell;
         5> for each of the configured NR frequencies in which measurements are available:
         6> if the SS/PBCH block-based measurement quantities are available:
         7> set the measResultListNR in measResultNeighCells to include all the available measurement quantities of the best measured cells, other than the source PCell, ordered such that the cell with highest SS/PBCH block RSRP is listed first if SS/PBCH block RSRP measurement results are available, otherwise the cell with highest SS/PBCH block RSRQ is listed first if SS/PBCH block RSRQ measurement results are available, otherwise the cell with highest SS/PBCH block SINR is listed first, based on the available SS/PBCH block based measurements collected up to the moment the UE detected radio link failure;
         8> for each neighbour cell included, include the optional fields that are available;
         6> if the CSI-RS based measurement quantities are available:
         7> set the measResultListNR in measResultNeighCells to include all the available measurement quantities of the best measured cells, other than the source PCell, ordered such that the cell with highest CSI-RS RSRP is listed first if CSI-RS RSRP measurement results are available, otherwise the cell with highest CSI-RS RSRQ is listed first if CSI-RS RSRQ measurement results are available, otherwise the cell with highest CSI-RS SINR is listed first, based on the available CSI-RS based measurements collected up to the moment the UE detected radio link failure;
         8> for each neighbour cell included, include the optional fields that are available;
         5> for each of the configured EUTRA frequencies in which measurements are available:
         6> set the measResultListEUTRA in measResultNeighCells to include the best measured cells ordered such that the cell with highest RSRP is listed first if RSRP measurement results are available, otherwise the cell with highest RSRQ is listed first, and based on measurements collected up to the moment the UE detected radio link failure;
         NOTE: The measured quantities are filtered by the L3 filter as configured in the mobility measurement configuration. The measurements are based on the time domain measurement resource restriction, if configured. Blacklisted cells are not required to be reported.
         5> if detailed location information is available, set the content of locationInfo as follows:
         6> if available, set the commonLocationInfo to include the detailed location information;
         6> if available, set the bt-LocationInfo in locationInfo to include the Bluetooth measurement results, in order of decreasing RSSI for Bluetooth beacons;
         6> if available, set the wlan-LocationInfo in locationInfo to include the WLAN measurement results, in order of decreasing RSSI for WLAN APs;
         6> if available, set the sensor-LocationInfo in locationInfo to include the sensor measurement results;
         5> set the failedPCellId to the global cell identity and the tracking area code, if available, and otherwise to the physical cell identity and carrier frequency of the PCell where radio link failure is detected;
         5> if an RRCReconfiguration message including the reconfigurationWithSync was received before the connection failure:
         6> if the last RRCReconfiguration message including the reconfigurationWithSync concerned an intra NR handover:
         7> include the previousPCellId and set it to the global cell identity and the tracking area code of the PCell where the last RRCReconfiguration message including reconfigurationWithSync was received;
         7> set the timeConnFailure to the elapsed time since reception of the last RRCReconfiguration message including the reconfigurationWithSync;
         5> set the connectionFailureType to rlf;
         5> set the c-RNTI to the C-RNTI used in the PCell;
         5> set the rlf-Cause to the trigger for detecting radio link failure;
         5> if the rlf-Cause is set to randomAccessProblem or beamFailureRecoveryFailure:
         6> set the absoluteFrequencyPointA to indicate the absolute frequency of the reference resource block associated to the random-access resources;
         6> set the locationAndBandwidth and subcarrierSpacing associated to the UL BWP of the random-access resources;
         6> set the msg1-FrequencyStart, msg1-FDM and msg1-SubcarrierSpacing associated to the random-access resources;
         6> set the parameters associated to individual random-access attempt in the chronological order of attmepts in the perRAInfoList as follows:
         7> if the random-access resource used is associated to a SS/PBCH block, set the associated random-access parameters for the successive random-access attempts associated to the same SS/PBCH block for one or more radom-access attempts as follows:
         8> set the ssb-Index to include the SS/PBCH block index associated to the used random-access resource;
         8> set the numberOfPreamblesSentOnSSB to indicate the number of successive random access attempts associated to the SS/PBCH block;
         8> for each random-access attempt performed on the random-access resource, include the following parameters in the chronological order of the random-access attempt:
         9> if contention resolution was not successful as specified in TS 38.321 v16.2.1 [6] for the transmitted preamble:
         10> set the contentionDetected to true;
         10> set the contentionDetected to false;
         9> if the SS/PBCH block RSRP of the SS/PBCH block corresponding to the random-access resource used in the random-access attempt is above rsrp-ThresholdSSB:
         10> set the dlRSRPAboveThreshold to true;
         9> else:
         10> set the dlRSRPAboveThreshold to false;
         7> else if the random-access resource used is associated to a CSI-RS, set the associated random-access parameters for the successive random-access attempts associated to the same CSI-RS for one or more radom-access attempts as follows:
         8> set the csi-RS-Index to include the CSI-RS index associated to the used random-access resource;
         8> set the numberOfPreamblesSentOnCSI-RS to indicate the number of successive random-access attempts associated to the CSI-RS;
         8> for each random-access attempt performed on the random-access resource, include the following parameters in the chronological order of the random-access attempt:
         9> if contention resolution was not successful as specified in TS 38.321 v16.2.1 [6] for the transmitted preamble:
         10> set the contentionDetected to true;
         9> else:
         10> set the contentionDetected to false;
         9> if the CSI-RS RSRP of the CSI-RS corresponding to the random-access resource used in the random-access attempt is above rsrp-ThresholdCSI-RS:
         10> set the dlRSRPAboveThreshold to true;
         9> else:
         10> set the dlRSRPAboveThreshold to false;
         4> if AS security has not been activated:
         5> perform the actions upon going to RRC_IDLE as specified in 5.3.11, with release cause ‘other’;
         4> else if AS security has been activated but SRB2 and at least one DRB or, for IAB, SRB2, have not been setup:
         5> store the radio link failure information in the VarRLF-Report as described in subclause 5.3.10.5;
         5> perform the actions upon going to RRC_IDLE as specified in 5.3.11, with release cause ‘RRC connection failure’;
         4> else:
         5> store the radio link failure information in the VarRLF-Report as described in subclause 5.3.10.5;
         5> if T316 is configured; and
         5> if SCG transmission is not suspended; and
         5> if PSCell change is not ongoing (i.e. timer T304 for the NR PSCell is not running in case of NR-DC or timer T307 of the E-UTRA PSCell is not running as specified in TS 36.331 [10], clause 5.3.10.10, in NE-DC):
         6> initiate the MCG failure information procedure as specified in 5.7.3b to report MCG radio link failure.
         5> else:
         6> initiate the connection re-establishment procedure as specified in 5.3.7.

The UE may discard the radio link failure information, i.e. release the UE variable VarRLF-Report, 48 hours after the radio link failure is detected.

The UE shall:
1> upon T310 expiry in PSCell; or
1> upon T312 expiry in PSCell; or
1> upon random access problem indication from SCG MAC; or
1> upon indication from SCG RLC that the maximum number of retransmissions has been reached; or
1> if connected as an IAB-node, upon BH RLF indication received on BAP entity from the SCG; or
1> upon consistent uplink LBT failure indication from SCG MAC:
   2> if the indication is from SCG RLC and CA duplication is configured and activated; and for the corresponding logical channel allowedServingCells only includes SCell(s):
      3> initiate the failure information procedure as specified in 5.7.5 to report RLC failure.
   2> else if MCG transmission is not suspended:
      3> consider radio link failure to be detected for the SCG, i.e. SCG RLF;
      3> initiate the SCG failure information procedure as specified in 5.7.3 to report SCG radio link failure.
   2> else:
      3> if the UE is in NR-DC:
         4> initiate the connection re-establishment procedure as specified in 5.3.7;
      3> else (the UE is in (NG) EN-DC):
         4> initiate the connection re-establishment procedure as specified in TS 36.331 [10], clause 5.3.7;

(End of Excerpt)

After the RLF is declared, the RLF report is logged and, once the wireless device selects a cell and succeeds with a reestablishment, it includes an indication that it has an RLF report available in the RRC Reestablishment Complete message, to make the target cell aware of that availability. Then, upon receiving an UEInformationRequest message with a flag “rlf-ReportReq-r16” the UE shall include the RLF report (stored in a UE variable VarRLF-Report, as described above) in an UEInformationResponse message and send the RLF report to the network.

The UEInformationRequest, and UEInformationResponse messages are shown below.

UEInformationRequest

The UEInformationRequest is the command used by E-UTRAN to retrieve information from the UE.
Signalling radio bearer: SRB1
RLC-SAP: AM
Logical channel: DCCH
Direction: E-UTRAN to UE

UEInformationRequest message

-- ASN1START
-- TAG-UEINFORMATIONREQUEST-START

| | |
|---|---|
| UEInformationRequest-r16 ::= | SEQUENCE { |
| rrc-TransactionIdentifier | RRC- |
| TransactionIdentifier, | |
| criticalExtensions | CHOICE { |
| ueInformationRequest-r16 | UEInformationRequest- |
| r16-IEs, | |
| criticalExtensionsFuture | SEQUENCE { } |
| } | |
| } | |
| UEInformationRequest-r16-IEs ::= | SEQUENCE { |
| idleModeMeasurementReq-r16 | ENUMERATED{true} |
| OPTIONAL, -- Need N | |
| logMeasReportReq-r16 | ENUMERATED {true} |
| OPTIONAL, -- Need N | |
| connEstFailReportReq-r16 | ENUMERATED {true} |
| OPTIONAL, -- Need N | |
| ra-ReportReq-r16 | ENUMERATED {true} |
| OPTIONAL, -- Need N | |
| rlf-ReportReq-r16 | ENUMERATED {true} |
| OPTIONAL, -- Need N | |
| mobilityHistoryReportReq-r16 | ENUMERATED {true} |
| OPTIONAL, -- Need N | |
| lateNonCriticalExtension | OCTET STRING |
| OPTIONAL, | |
| nonCriticalExtension | SEQUENCE { } |
| OPTIONAL | |
| } | |

UEInformationRequest-IEs field descriptions

connEstFailReportReq
This field is used to indicate whether the UE shall report information about the
connection failure.
idleModeMeasurementReq
This field indicates that the UE shall report the idle/inactive measurement
information, if available, to the network in the UEInformationResponse message.
logMeasReportReq
This field is used to indicate whether the UE shall report information about
logged measurements.
mobilityHistoryReportReq
This field is used to indicate whether the UE shall report information about
mobility history information.
ra-ReportReq
This field is used to indicate whether the UE shall report information about the
random access procedure.
rlf-ReportReq
This field is used to indicate whether the UE shall report information about the
radio link failure.

UEInformationResponse

The UEInformationResponse message is used by the UE to transfer information requested by the network.
Signalling radio bearer: SRB1 or SRB2 (when logged measurement information is included)
RLC-SAP: AM
Logical channel: DCCH
Direction: UE to network

UEInformationResponse message

-- ASN1START
-- TAG-UEINFORMATIONRESPONSE-START

| | |
|---|---|
| UEInformationResponse-r16 ::= | SEQUENCE { |
| rrc-TransactionIdentifier | RRC- |

TransactionIdentifier,

| | |
|---|---|
| criticalExtensions | CHOICE { |

ueInformationResponse-r16
UEInformationResponse-r16-IEs,

| | |
|---|---|
| criticalExtensionFuture | SEQUENCE { } |

}
}

| | |
|---|---|
| UEInformationRespose-r16-IEs ::= | SEQUENCE { |
| measResultIdleEUTRA-r16 | MeasResultIdleEUTRA- |

r16 OPTIONAL,

| | |
|---|---|
| measResultIdleNR-r16 | MreasResultIdleNR-r16 |

OPTIONAL,

| | |
|---|---|
| logMeasReport-r16 | LogMeasReport-r16 |

OPTIONAL,

| | |
|---|---|
| connEstFailReport-r16 | ConnEstFailReport-r16 |

OPTIONAL,

| | |
|---|---|
| ra-ReportList-r16 | RA-ReportList-r16 |

OPTIONAL,

| | |
|---|---|
| rlf-Report-r16 | RLF-Report-r16 |

OPTIONAL,
mobilityHistoryReport-r16

| | |
|---|---|
| MobilityHisotryReport-r16 | OPTIONAL, |
| lateNonCriticalExtension | OCTET STRING |

OPTIONAL,

| | |
|---|---|
| nonCriticalExtension | SEQUENCE { } |

OPTIONAL
}

| | |
|---|---|
| LogMeasReport-r16 ::= | SEQUENCE { |
| absoluteTimeStamp-r16 | AbsoluteTimeInfo-r16, |
| traceReference-r16 | TraceReference-r16, |
| traceRecordingSessionRef-r16 | OCTET STRING (SIZE |

(2)),

| | |
|---|---|
| tce-Id-r16 | OCTET STRING (SIZE |

(1)),

| | |
|---|---|
| logMeasInfoList-r16 | LogMeasInfoList-r16, |
| logMeasAvailable-r16 | ENUMERATED {true} |

OPTIONAL,

| | |
|---|---|
| logMeasAvailableBT-r16 | ENUMERATED {true} |

OPTIONAL,

| | |
|---|---|
| logMeasAvailableWLAN-r16 | ENUMERATED {true} |

OPTIONAL,
...
}

| | |
|---|---|
| LogMeasInfoList-r16 ::= | SEQUENCE (SIZE |

(1..maxLogMeasReport-r16)) OF LogMeasInfo-r16

| | |
|---|---|
| LogMeasInfo-r16 ::= | SEQUENCE { |
| locationInfo-r16 | LocationInfo-r16 |

OPTIONAL,

| | |
|---|---|
| relativeTimeStamp-16 | INTEGER (0..7200), |
| serveCellIdentity-r16 | CGI-Info-Logging-r16 |

OPTIONAL,
measReultServingCell-r16

| | |
|---|---|
| MeasResultServingCell-r16 | OPTIONAL, |
| measResultNeighCells-r16 | SEQUENCE { |

measResultNeighCellListNR

| | |
|---|---|
| MeasResultListLogging2NR-r16 | OPTIONAL, |

measResultNeighCellListEUTRA

| | |
|---|---|
| MeasResultList2EUTRA-r16 | OPTIONAL |

},

| | |
|---|---|
| anyCellSelectionDetected-r16 | ENUMERATED (true) |

OPTIONAL
}

| | |
|---|---|
| ConnEstFailReport-r169 ::= | SEQUENCE { |
| measResultFailedCell-r16 | MeasResultFailedCell- |

r16,

| | |
|---|---|
| locationInfo-r16 | LocationInfo-r16 |

OPTIONAL,

| | |
|---|---|
| measResultNeighCells-r16 | SEQUENCE { |

measResultNeighCellListNR

| | |
|---|---|
| MeasResultList2NR-r16 | OPTIONAL, |

measResultNeighCellListEUTRA

| | |
|---|---|
| MeasResultList2EUTRA-r16 | OPTIONAL |

},

| | |
|---|---|
| numberOfConnFail-r16 | INTEGER (1..8), |
| perRAInfoList-r16 | PerRAInfoList-r16, |
| timeSinceFailure-r16 | TimeSinceFailure-r16, |

...
}

| | |
|---|---|
| MeasResultServingCell-r16 ::= | SEQUENCE { |
| resultsSSB-Cell | MeasQuantityResults, |
| resultsSSB | SEQUENCE { |
| best-ssb-Index | SSB-Index, |

best-ssb-Results
MeasQuantityResults,

| | |
|---|---|
| numberOfGoodSSB | INTEGER |

(1..maxNrofSSBs-r16)
}
OPTIONAL
}

| | |
|---|---|
| MeasResultFailedCell-r16 ::= | SEQUENCE { |
| cgi-Info | CGI-Info-Logging-r16, |
| measResult-r16 | SEQUENCE { |
| cellResults-r16 | SEQUENCE { |

```
      resultsSSB-Cell-r16
MeasQuantityResults
    },
```

| | |
|---|---|
| rsIndexResults-r16 | SEQUENCE { |

```
      resultsSSB-Indexes-r16
ResultsPerSSB-IndexList
    }
  }
}
RA-ReportList-r16 ::= SEQUENCE (SIZE (1..maxRAReport-r16)) OF
RA-Report-r16
```

| | |
|---|---|
| RA-Report-r16 ::= | SEQUENCE { |
| cellId-r16 | CGI-Info-Logging-r16, |
| RA-InformationCommon-r16 | RA-InformationCommon- |

r16,

| | |
|---|---|
| raPurpose-r16 | ENUMERATED |

{accessRelated, beamFailureRecovery, reconfigurationWithSync,
ulUnSynchronized,
schedulingRequestFailure, noPUCCHResourceAvailable,
requestForOtherSI,

spare9,

spare8, spare7, spare6, spare5, spare4, spare3, spare2,
spare1}
}

| | |
|---|---|
| RA-InformationCommon-r16 : := | SEQUENCE { |
| absoluteFrequencyPointA-r16 | ARFCN-ValueNR, |
| locationAndBandwidth-r16 | INTEGER (0..37949) , |
| subcarrierSpacing-r16 | SubcarrierSpacing, |
| msg1-FrequencyStart-r16 | INTEGER |
| (0..maxNrofPhysicalResourceBlocks-1) | OPTIONAL, |
| msg1-FrequencyStartCFRA-r16 | INTEGER |
| (0..maxNrofPhysicalResourceBlocks-1) | OPTIONAL, |
| msg1-SubcarrierSpacing-r16 | SubcarrierSpacing |

OPTIONAL,

| | |
|---|---|
| msg1-SubcarrierSpacingCFRA-r16 | SubcarrierSpacing |

OPTIONAL,

| | |
|---|---|
| msg1-FDM-r16 | ENUMERATED {one, two, |

four, eight} OPTIONAL,

| | |
|---|---|
| msg1-FDMCFRA-r16 | ENUMERATED {one, two, |

four, eight} OPTIONAL,

| | |
|---|---|
| perRAInfoList-r16 | PerRAInfoList-r16 |

}
PerRAInfoList-r16 ::= SEQUENCE (SIZE (1..200)) OF PerRAInfo-
r16

| | |
|---|---|
| PerRAInfoList-r16 ::= | CHOICE { |
| perRASSBInfoList-r16 | PerRASSBInfo-r16, |
| perRACSI-RSInfoList-r16 | PerRACSI-RSInfo-r16 |

}

| | |
|---|---|
| PerRASSBInfo-r16 ::= | SEQUENCE { |
| ssb-Index-r16 | SSB-Index, |
| numberOfPreamblesSentOnSSB-r16 | INTEGER (1..200), |
| perRAAttemptInfoList-r16 | PerRAAttemptInfoList- |

r16
}

| | |
|---|---|
| PerRACSI-RSInfo-r16 ::= | SEQUENCE { |
| csi-RS-Index-r16 | CSI-RS-Index, |
| numberOfPreamblesSentOnCSI-RS-r16 | INTEGER (1..200) |

}

| | |
|---|---|
| PerRAAttemptInfoList-r16 ::= | SEQUENCE (SIZE (1.200)) |

OF PerRAAttemptInfo-r16

| | |
|---|---|
| PerRAAttemptInfo-r16 ::= | SEQUENCE { |
| contentionDetected-r16 | BOOLEAN |

OPTIONAL,

| | |
|---|---|
| dlRSRPAboveThreshold-r16 | BOOLEAN |

OPTIONAL,
...
}

| | |
|---|---|
| RLF-Report-r16 ::= | CHOICE { |
| nr-RLF-Report-r16 | SEQUENCE { |
| measResultLastServCell-r16 | MeasResultRLFNR- |

r16,

| | |
|---|---|
| measResultNeighCells-r16 | SEQUENCE { |

```
      measResultListNR-r16
MeasResultList2NR-R16 OPTIONAL,
      measResultListEUTRA-r16
MeasResultList2EUTRA-r16 OPTIONAL
    }
OPTIONAL,
```

| | |
|---|---|
| c-RNTI-r16 | RNTI-Value, |
| previousPCellId-r16 | CHOICE { |
| nrPreviousCell-r16 | CGI-Info- |

Logging-r16,

| | |
|---|---|
| eutraPreviousCell-r16 | CGI- |

InfoEUTRALogging
}
OPTIONAL,

| | |
|---|---|
| failedPCellId-r16 | CHOICE { |
| nrFailedPCellId-r16 | CHOICE { |
| cellGlobalId-r16 | CGI-Info- |

Logging-r16,

| | |
|---|---|
| pci-arfcn-r16 | SEQUENCE |

```
{
          physCellId-r16
PhysCellId,
          carrierFreq-r16
ARFCN-ValueNR
        }
      },
```

| | |
|---|---|
| eutraFailedPCellId-r16 | CHOICE { |
| cellGlobalId-r16 | CGI- |

InfoEUTRALogging,

| | |
|---|---|
| pci-arfcn-r16 | SEQUENCE { |
| physCellId-r16 | EUTRA- |

PhysCellId,

| | |
|---|---|
| carrierFreq-r16 | ARFCN- |

```
ValueEUTRA
        }
      }
    },
```

| | |
|---|---|
| reconnectCellId-r16 | CHOICE { |
| nrReconnectCellId-r16 | CGI-Info- |

Logging-r16,

| | |
|---|---|
| eutraReconnectCellId-r16 | CGI- |

```
InfoEUTRALogging
    }
OPTIONAL,
    timeUntilReconnection-16
```

| | |
|---|---|
| TimeUntilReconnection-16 | OPTIONAL, |
| reestablishmentCellId-r16 | CGI-Info-Logging- |
| r16 | OPTIONAL, |
| timeConnFailure-r16 | INTEGER (0..1023) |

OPTIONAL,

| | |
|---|---|
| timeSinceFailure-r16 | TimeSinceFailure- |

r16,

| | |
|---|---|
| connectionFailureType-r16 | ENUMERATED {rlf, |

hof},

| | |
|---|---|
| rlf-Cause-r16 | ENUMERATED {t310- |

Expiry, randomAccessProblem, rlc-MaxNumRetx,
breamFailureRecoveryFailure, lbtFauilure-r16,

bh-

rlfRecoveryFailure, spare2, spare1}.

| | |
|---|---|
| locationInfo-r16 | LocationInfo-r16 |

OPTIONAL,

| | |
|---|---|
| noSuitableCellFound-r16 | ENUMERATED (true) |

OPTIONAL,

| | |
|---|---|
| ra-InformationCommon-r16 | RA- |
| InformationCommon-r16 | OPTIONAL |

},

| | |
|---|---|
| eutra-RLF-Report-r16 | SEQUENCE { |
| failedPCellId-EUTRA | CGI- |

InfoEUTRALogging,

| | |
|---|---|
| measResult-RLF-Report-EUTRA-r16 | OCTET STRING |

}
}

| | |
|---|---|
| MeasResultList2NR-r16 ::= | SEQUENCE (SIZE |

(1..maxFreq)) OF MeasResult2NR-r16

| | |
|---|---|
| MeasResultList2EUTRA-r16 ::= | SEQUENCE (SIZE |

(1..maxFreq)) OF MeasResult2RUTRA-r16

| | |
|---|---|
| MeasResult2NR-r16 ::= | SEQUENCE { |
| ssbFrequency-r16 | ARFCN-ValueNR |

OPTIONAL,

| | |
|---|---|
| refFreqCSI-RS-r16 | ARFCN-ValueNR |

OPTIONAL,

| | |
|---|---|
| measResultList-r16 | MeasResultListNR |

}

| | |
|---|---|
| MeasResultListLogging2NR-r16 ::= | SEQUENCE (SIZE |

(1..maxFreq)) OF MeasResultListLoggingNR-r16

| | |
|---|---|
| MeasResultLogging2NR-r16 ::= | SEQUENCE { |
| carrierFreq-r16 | ARFCN-ValueNR |

measResultListloggingNR-r16
MeasResultListLoggingNR-r16
}

| | |
|---|---|
| MeasResultListLoggingNR-r16 ::= | SEQUENCE (SIZE |

(1..maxCellReport)) OF MeasResultLoggingNR-r16

| | |
|---|---|
| MeasResultLoggingNR-r16 ::= | SEQUENCE { |
| physCEllId-r16 | PhysCellId, |
| resultsSSB-Cell-r16 | MeasQuantityResults, |
| numberOfGoodSSB-r16 | INTEGER |

(1..maxNrofSSBs-r16) OPTIONAL
}

| | |
|---|---|
| MeasResult2EUTRA-r16 ::= | SEQUENCE { |
| carrierFreq-r16 | ARFCN-ValueEUTRA, |
| measResultList-r16 | MeasResultListEUTRA |

}

| | |
|---|---|
| MeasResultRLFNR-r16 ::= | SEQUENCE { |
| measResult-r16 | SEQUENCE { |
| cellResults-r16 | SEQUENCE { |

resultsSSB-Cell-r16

| | |
|---|---|
| MeasQuantityResults | OPTIONAL, |

resultsCSI-RS-Cell-r16

| | |
|---|---|
| MeasQuantityResults | OPTIONAL |

},

| | |
|---|---|
| rsIndexResults-r16 | SEQUENCE{ |

resultsSSB-Indexes-r16

| | |
|---|---|
| ResultsPerSSB-IndexList | OPTIONAL, |
| ssbRLMConfigBitmap-r16 | BIT STRING |
| (SIZE (64)) | OPTIONAL, |

resultsCSI-RS-Indexes-r16

| | |
|---|---|
| ResultsPerCSI-RS-IndexList | OPTIONAL, |
| csi-rsRLMConfigBitmap-r16 | BIT STRING |
| (SIZE (96)) | OPTIONAL |

```
    }
OPTIONAL
  }
}
TimeSinceFailure-r16 ::= INTEGER (0..172800)
MobilityHistoryReport-r16 ::= VisitedCellInfoList-r16
TimeUntilReconnection-16 ::= INTEGER (0..172800)
-- TAG-UEINFORMATIONRESPONSE-STOP
-- ASN1STOP
```

Based on the contents of the RLF report (e.g. the Globally unique identity of the last serving cell, where the failure was originated), the cell in which the UE re-establishes can forward the RLF report to the last serving cell. This forwarding of the RLF report is done to aid the original serving cell with tuning of the handover related parameters (e.g. measurement report triggering thresholds) as the original serving cell was the one who had configured the parameters associated to the wireless device that led to the RLF.

Two different types of inter-node messages have been standardized in LTE for that purpose, the Failure indication and the handover report (in TS 38.423 v16.3.0).

The Radio link failure indication procedure is used to transfer information regarding RRC re-establishment attempts or received RLF reports between gNBs. This message is sent from the eNB in which the wireless device performs reestablishment to the eNB which was the previous serving cell of the wireless device.

Successful Handover Report

In the rel-16 discussions of Self Organising Networks (SON) and Minimization of Drive Testing (MDT), the concept of successful handover report was captured in the TR 37.816 v16.0.0. The concept of a successful handover report is to send some additional information to the target cell upon successfully completing a handover so that some additional knowledge that is available at the wireless device about the radio conditions, failure possibilities etc. is transferred to the network so that the network can further tune the handover parameters. The following aspects are captured in the TR 37.816 v16.0.0.

The mobility robustness optimization (MRO) function in NR could be enhanced to provide a more robust mobility via reporting failure events observed during successful handovers. A solution to this problem is to configure the wireless device to compile a report associated with a successful handover comprising a set of measurements collected during the handover phase, i.e. measurement at the handover trigger, measurement at the end of handover execution or measurement after handover execution. The wireless device could be configured with triggering conditions to compile the Successful Handover Report, hence the report would be triggered only if the conditions are met. This limits wireless device reporting to relevant cases, such as underlying issues detected by radio link monitoring (RLM), or beam failure detection (BFD) detected upon a successful handover event.

The availability of a Successful Handover Report may be indicated by the Handover Complete message (RRCReconfigurationComplete) transmitted from wireless device to the target NG-RAN node over RRC. The target NG-RAN node may fetch information of a successful handover report via a UE Information Request/Response mechanism. In addition, the target NG-RAN node may then forward the Successful Handover Report to the source NR-RAN node to indicate failures experienced during a successful handover event.

The information contained in the successful handover report may comprise:
RLM related information
   RLM related timers (e.g. T310, T312)
   Measurements of reference signals used for RLM in terms of RSRP, RSRQ, SINR
   RLC retransmission counter
Beam failure detection (BFD) related information
   Detection indicators and counters (e.g. Qin and Qout indications)
   Measurements of reference signals used in BFD in terms of RSRP, RSRQ, SINR
Handover related information
   Measurements of the configured reference signals at the time of successful handover
      SSB beam measurements
      CSI-RS measurements
   Handover related timers (e.g. T304)
   Measurement period indication, i.e. measurements are collected at handover trigger, at the end of handover execution or just after handover execution

Upon reception of a Successful HO Report, the receiving node may then be able to analyse whether a mobility configuration associated with handover needs to be adjusted. Such adjustments may result in changes of mobility configurations, such as changes of RLM configurations or changes of mobility thresholds between the source and the target. In addition, target NG RAN node, in the performed handover, may further optimize the dedicated RACH-beam resources based on the beam measurements reported upon successful handovers.

Conditional Handover in Rel-16

Handovers are normally triggered when the wireless device is at the cell edge and experiences poor radio conditions. If the wireless device enters poor radio conditions quickly, the conditions may already be so poor that the actual handover procedure may be hard to execute. If the UL is already bad it may mean that the network is not able to detect the measurement report transmitted by the wireless device, and hence cannot initiate the handover procedure. DL problems may mean that the handover command (i.e. the RRCReconfiguration message with a reconfigurationWithSync field) cannot successfully reach the wireless device. In poor radio conditions the DL message is more often segmented, which increases the risk of retransmissions with an increased risk that the message doesn't reach the wireless device in time. Failed transmission of handover command is a common reason for unsuccessful handovers.

To improve mobility robustness and address the issues above, a concept known as conditional handover (CHO) is being introduced in 3GPP Release 16. The key idea in CHO is that transmission and execution of the handover command are separated. This allows the handover command to be sent earlier to wireless device when the radio conditions are still good, thus increasing the likelihood that the message is successfully transferred. The execution of the handover command is then performed at later point in time based on an associated execution condition. The execution condition is typically in the form a threshold, e.g. signal strength of candidate target cell becomes X dB better than the serving cell (so called A3 event) or signal strength of serving cell becomes worse than X dBm and signal strength of candidate target cell becomes better than Y dBm (so called A5 event).

In the context of this document, a cell for which conditional handover (or other conditional mobility procedure) is configured is denoted “candidate target cell” or “potential target cell”. Similarly, a radio network node controlling a candidate/potential target cell is denoted “candidate target node” or “potential target node”. In a sense, once the CHO execution condition has been fulfilled for a candidate/potential target cell and CHO execution towards this candidate/potential target cell has been triggered, this cell is no longer “potential” or a “candidate” in the normal senses of the words, since it is no longer uncertain whether the CHO will be executed towards it. Hence, after the CHO execution condition has been fulfilled/triggered, the concerned candidate/potential target cell is herein sometimes referred to as “target cell”.

FIG. 2 shows the signaling flow for a conditional handover.

In steps 2001-2002 The UE and source gNB have an established connection and are exchanging user data. Due to some trigger, e.g. a measurement report from the UE, the source gNB decides to configure one or multiple CHO candidate cells. The threshold used for the measurement reporting may be chosen lower than a threshold using in the handover execution condition. This allows the serving cell to prepare the handover when the radio link to the UE is still stable. The execution of the handover is done at a later point in time (and threshold) which is considered optimal for the handover execution.

In Steps 2003-2004 the source node transmits a handover request to the target node, and the target node acknowledges the request. The source node indicates that the handover is a conditional handover.

In steps 2005-2006, to configure a candidate target cell the source node sends the CHO configuration (i.e. a RRCReconfiguration message) to the UE which comprises the handover command and the associated execution condition. The handover command (also an RRCReconfiguration message) is generated by the target node during the handover preparation phase and the execution condition is generated by the source node.

In steps 2007-2008 if the execution condition is met, the UE executes the handover by performing random access and sending the handover complete message (i.e. an RRCReconfigurationComplete message) to the target node.

In step 2009 the target gNB sends a HANDOVER SUCCESS message to the source gNB indicating the UE has successfully established the target connection.

In steps 2010-2011, upon reception of the handover success indication, the source gNB stops scheduling any further DL or UL data to the UE and sends a SN STATUS TRANSFER message to the target gNB indicating the latest PDCP SN transmitter and receiver status. The source node now also starts to forward User Data to the target node.

In step 2012 the target node instructs the source node to release the UE context for the UE.

There currently exist certain challenge(s).

Considering the current state of the NR RRC TS 38.331 v16.2.0, when a wireless device declares an RLF shortly after a successful handover, the wireless device logs information to be sent to the network and the corresponding RAN node to resolve the root causes of the issues e.g., changing the mobility parameters. This is shown in the following excerpt of the specification.

Excerpt from TS 38.331 v 16.2.0
1> else if the failure is detected due to radio link failure as described in 5.3.10.3, set the fields in VarRLF-report as follows:
   2> set the connectionFailureType to rlf;
   2> set the rlf-Cause to the trigger for detecting radio link failure in accordance with clause 5.3.10.4;
   2> set the nrFailedPCellId in failedPCellId to the global cell identity and the tracking area code, if available, and otherwise to the physical cell identity and carrier frequency of the PCell where radio link failure is detected;
   2> if an RRCReconfiguration message including the reconfigurationWithSync was received before the connection failure:
      3> if the last RRCReconfiguration message including the reconfigurationWithSync concerned an intra NR handover:
         4> include the nrPreviousCell in previousPCellId and set it to the global cell identity and the tracking area code of the PCell where the last RRCReconfiguration message including reconfigurationWithSync was received;
         4> set the timeConnFailure to the elapsed time since reception of the last RRCReconfiguration message including the reconfigurationWithSync; 3> else if the last RRCReconfiguration message including the reconfigurationWithSync concerned a handover to NR from E-UTRA and if the UE supports Radio Link Failure Report for Inter-RAT MRO:
         4> include the eutraPreviousCell in previousPCellId and set it to the global cell identity and the tracking area code of the E-UTRA PCell where the last RRCReconfiguration message including reconfigurationWithSync was received embedded in E-UTRA RRC message MobilityFromEUTRACommand message as specified in TS 36.331 clause 5.4.3.3;
         4> set the timeConnFailure to the elapsed time since reception of the last RRCReconfiguration message including the reconfigurationWithSync embedded in E-UTRA RRC message MobilityFromEUTRACommand message as specified in TS 36.331 clause 5.4.3.3;

(End Excerpt)

As highlighted in the above excerpt, when an RLF happens and a wireless device receives an RRC Reconfiguration which includes reconfigurationWithSync (which means that the wireless deivce performed a successful handover before the radio link failure), the wireless device logs the PCell identity included in that RRC reconfiguration and the time elapsed since receiving that RRC Reconfiguration message until the failure.

This procedure helps the network to detect Too Early HOs or HO to wrong cells as explained below:

Detection of Too Early HO: If a wireless device performs a successful handover from Cell A to Cell B, fails after a successful HO at Cell B, and then re-establishes a connection to Cell B, it logs as part of RLF report the PCell identity included in the last RRC Reconfiguration which conveyed reconfigurationWithSync command (e.g. Cell A). The RLF report may then be sent from Cell B to Cell A, so Cell A (having the timeConnfailure) would then be able to recognize that it performed a Too Early HO, and may fix the issue by changing the mobility parameters relating to handover.

Detection of HO Too Wrong Cell: If a wireless device performs a successful handover from Cell A to Cell B, fails after a successful HO at Cell B, and re-establishes a connection to Cell C, the wireless device logs as part of RLF report the PCell identity included in the last RRC Reconfiguration which conveyed reconfigurationWithSync command (e.g. Cell A). The RLF report may then be transmitted from Cell C to Cell B, and then form Cell B to Cell A. Therefore, Cell A (having the timeConnfailure) would recognize it performed a HO to Wrong Cell, and may fix the issue by changing the mobility parameters.

However, the above procedural text does not distinguish different types of the handovers. In fact, if the initiated handover before failure was a conditional handover a different set of parameters (pertained to conditional handover) should be fixed, compared to the normal handover parameters. In fact, considering the current set of information provided as part of RLF report for detection of Too Early HO and HO to Wrong cell, it is not possible for a RAN node (analyzing the content of the RLF report) to detect whether the HO was, for example, a normal handover, a CHO handover, a DAPS handover, or a DAPS handover combined with CHO handover.

The same problem exists when a wireless device performs a successful Secondary Cell Group (SCG) change in a dual connectivity scenario, and then fails after the successful SCG change. It would not be possible for the network to detect whether the SCG change was a conditional SCG change or a normal SCG change.

### SUMMARY

An aspect of an embodiment of the disclosure provides a method performed by a wireless device for reporting handover related information to a base station for mobility parameter optimization, the method comprising: responsive to detection of a radio link failure or a Secondary Cell Group, SCG, failure after a successful handover, transmitting an indication of a handover type of the successful handover to the base station.

A further aspect of an embodiment of the disclosure provides a method performed by a base station for receiving handover related information for mobility parameter optimization, the method comprising: responsive to a radio link failure or a Secondary Cell Group, SCG, failure occurring after a successful handover of a wireless device, receiving an indication of a handover type of the successful handover.

A further aspect of an embodiment of the disclosure provides a wireless device for transmitting handover related information for mobility parameter optimization, the wireless device comprising: processing circuitry configured to: responsive to detection of a radio link failure or a Secondary Cell Group, SCG, failure after a successful handover, transmit an indication of a handover type of the successful handover to a base station; and power supply circuitry configured to supply power to the wireless device.

A further aspect of an embodiment of the disclosure provides a base station for receiving handover related information for mobility parameter optimization, the base station comprising: processing circuitry configured to: responsive to a radio link failure or a Secondary Cell Group, SCG, failure occurring after a successful handover of a wireless device, receive an indication of a handover type of the successful handover; and power supply circuitry configured to supply power to the base station.

### BRIEF DESCRIPTION OF DRAWINGS

For better understanding of the present disclosure, and to show how it may be put into effect, reference will now be made, by way of example only, to the accompanying drawings, in which:

FIG. 1 is a diagram of higher layer RLF related procedures in LTE;

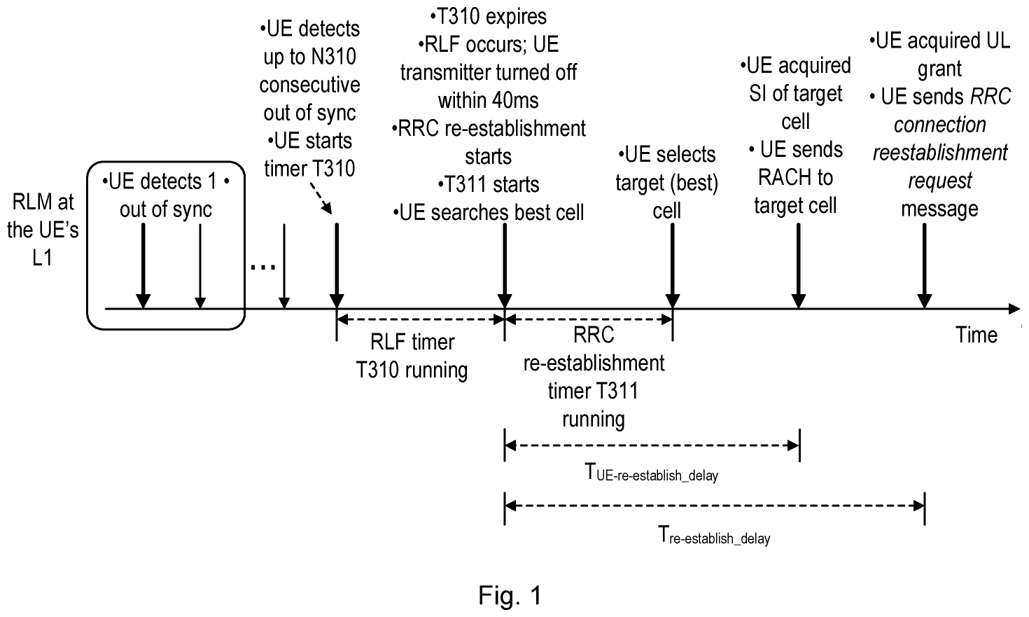

FIG. 2 shows a signalling flow for a conditional handover;

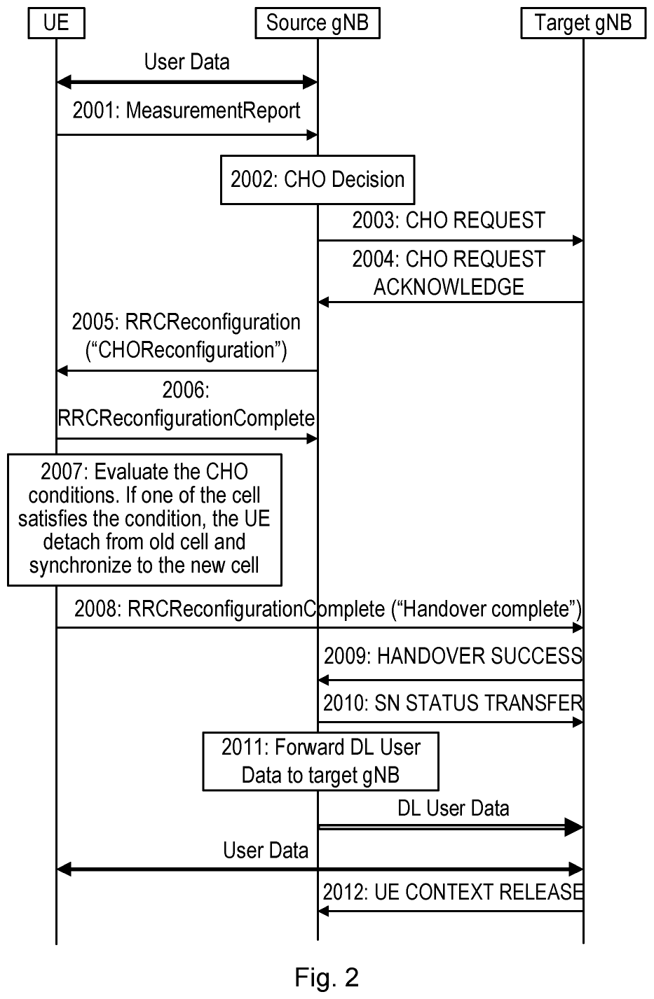

FIG. 3 illustrates a method performed by a wireless device for reporting handover related information to a base station for mobility parameter optimization.

FIG. 4 illustrates a method performed by a base station method performed by a base station for receiving handover related information for mobility parameter optimization.

FIG. 5 illustrates an example implementation of the method of FIG. 3.

FIG. 6 is a schematic diagram of a wireless network in accordance with some embodiments;

FIG. 7 is a schematic diagram of a user equipment in accordance with some embodiments;

FIG. 8 is a schematic diagram of a virtualization environment in accordance with some embodiments;

FIG. 9 is a schematic diagram of a telecommunication network connected via an intermediate network to a host computer in accordance with some embodiments;

FIG. 10 is a schematic diagram of a host computer communicating via a base station with a user equipment over a partially wireless connection in accordance with some embodiments;

FIG. 11 is a flowchart showing methods implemented in a communication system including a host computer, a base station and a user equipment in accordance with some embodiments;

FIG. 12 is a flowchart showing methods implemented in a communication system including a host computer, a base station and a user equipment in accordance with some embodiments;

FIG. 13 is a flowchart showing methods implemented in a communication system including a host computer, a base station and a user equipment in accordance with some embodiments;

FIG. 14 is a flowchart showing methods implemented in a communication system including a host computer, a base station and a user equipment in accordance with some embodiments;

FIG. 15 illustrates a schematic block diagram of an apparatus in a wireless network; and

FIG. 16 illustrates a schematic block diagram of an apparatus in a wireless network.

### DETAILED DESCRIPTION

Certain aspects of the present disclosure and their embodiments may provide solutions to the challenges identified above, or other challenges.

It will be appreciated that the terms “handover” and “reconfiguration with sync” are used herein interchangeably, and they refer to the same mobility procedure in this document. The terms wireless device and user equipment (UE) are also be used interchangeably herein.

Embodiments described herein provide methods and apparatuses for reporting CHO related measurement information for mobility parameter optimization.

A method in a wireless device comprises upon detection of a radio link failure after a successful reconfiguration with sync or after a successful handover, after a successful conditional handover, after a successful conditional handover combined with DAPS handover, or a successful DAPS handover, the UE may log and report to the network at least one of the following information:

An indication, indicating the handover type of the last successful handover before the radio link failure, the handover type can be normal/legacy handover, conditional handover, or conditional handover combined with DAPS handover or a DAPS handover.

An indication indicating whether the re-establishment cell (the cell that is selected for a successful re-establishment) after the radio link failure that happened after the successful handover was a candidate cell (or a prepared cell) that was in the list of the candidate cells within ConditionalReconfiguration received as part of CHO execution configuration.

An indication indicating whether the reconnect cell ID (the cell that is selected after a failed re-establishment procedure and after a transition from RRC_Connected mode to the RRC_IDLE mode) was for a CHO prepared (or CHO candidate) cell that was within the list of the candidate cells in ConditionalReconfiguration received as part of CHO execution configuration.

There are, proposed herein, various embodiments which address one or more of the issues disclosed herein.

Certain embodiments may provide one or more of the following technical advantage(s).

Embodiments described herein allow for the source node of a successful handover to be aware of whether the handover causing a Too Early Handover or the HO to wrong cell was a normal/legacy handover, a DAPS handover, a conditional handover or a conditional handover combined with DAPS handover. Knowing this information, the source node of the successful handover can tune the parameters corresponding to the type of handover that actually caused the failure.

Embodiments described herein also allow for RAN nodes to decide whether or not to add a re-establishment cell or a reconnect cell after a radio link failure to a list of candidate cells for conditional handover.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art. For the avoidance of doubt, the scope of the invention is defined by the claims.

In embodiments described herein the wireless device stores handover failure related information including some indications indicating whether the last successful handover before the last radio link failure was a normal legacy handover, a conditional handover, a DAPS handover, or a conditional handover combined with DAPS handover. Embodiments described herein provide methods executed by a wireless device (also called a User Equipment—UE) and a base station for reporting CHO related information for mobility parameter optimization.

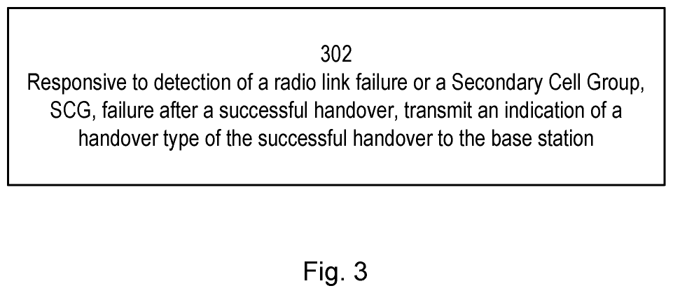

FIG. 3 illustrates a method performed by a wireless device for reporting handover related information to a base station for mobility parameter optimization.

In step 301, the method comprises responsive to detection of a radio link failure or a Secondary Cell Group, SCG, failure after a successful handover, transmitting an indication of a handover type of the successful handover to the base station.

In some examples, the method further comprises logging the handover type in a radio link failure report and transmitting the radio link failure report to the base station.

The handover type may comprise one or more of: a normal (or legacy) handover, a conditional handover, a conditional handover combined with a Dual Active Protocol Stack, DAPS, handover, or a DAPS handover.

In some dual connectivity examples, the successful handover comprises a Primary Secondary Cell, PSCell, change in a dual connectivity scenario. The handover type may comprise one of: a normal (or legacy) SCG change, a conditional SCG change, a conditional PSCell change, a conditional SCG change combined with a DAPS handover, or a DAPS SCG change.

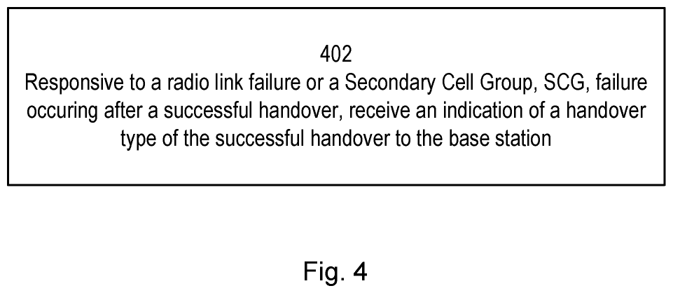

FIG. 4 illustrates a method performed by a base station method performed by a base station for receiving handover related information for mobility parameter optimization.

In step 401, the method comprises responsive to a radio link failure or a Secondary Cell Group, SCG, failure occurring after a successful handover of a wireless device, receiving an indication of a handover type of the successful handover.

The indication of the handover type may be received as part of a radio link failure report. The radio link failure report may be received from another base station.

The handover type may comprise one or more of: a normal (or legacy) handover, a conditional handover, a conditional handover combined with a Dual Active Protocol Stack, DAPS, handover, or a DAPS handover.

In some dual connectivity examples, the successful handover comprises a Primary Secondary Cell, PSCell, change in a dual connectivity scenario. The handover type may comprise one of: a normal (or legacy) SCG change, a conditional SCG change, a conditional PSCell change, a conditional SCG change combined with a DAPS handover, or a DAPS SCG change.

Responsive to receiving the indication of the handover type the base station may adjust parameters associated with the handover type. For example, the base station may adjust the parameters in order to attempt to avoid the failure occurring again.

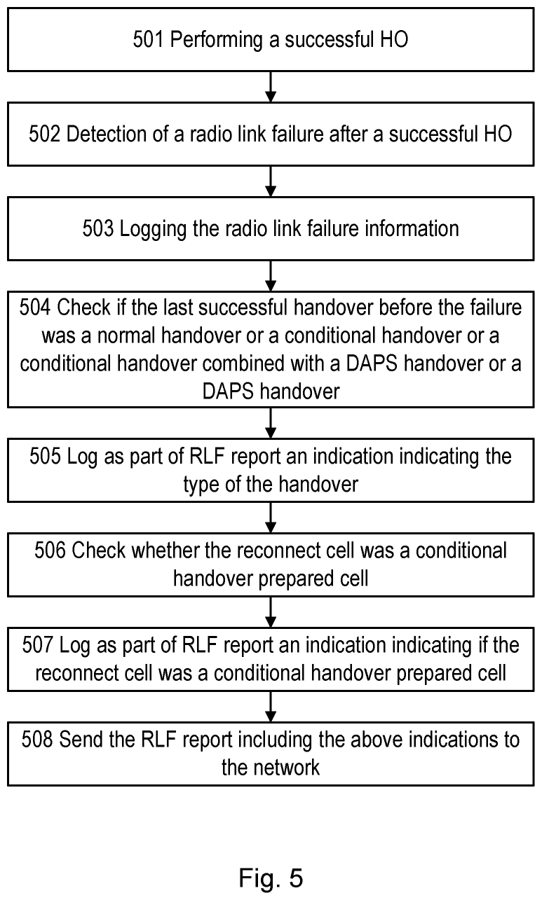

FIG. 5 illustrates an example implementation of the method of FIG. 3.

In step 501 of FIG. 5, a successful handover of a wireless device from a source base station to a target base station. As previous mentioned, the successful handover may be: a legacy handover, a conditional handover, a conditional handover combined with a DAPS handover, or a DAPS handover.

The successful handover may alternatively be a normal SCG change, a conditional SCG change, a conditional PSCell change, a conditional SCG change combined with a DAPS handover, or a DAPS SCG change.

In step 502 of FIG. 5, a radio link failure of a SCG failure is detected. The radio link failure may be any radio link failure, for example, as described in the background section.

In step 503 of FIG. 5, the wireless device logs the radio link failure information. In particular, the radio link failure information is logged in a RLF report.

In step 504 of FIG. 5, the wireless device checks the handover type of the successful handover. In step 505 the wireless device logs the handover type of the successful handover.

In step 506, responsive to the successful handover being conditional, the wireless device checks whether the reconnect cell or re-establishment cell, was a conditional handover prepared cell for the successful handover. The reconnect cell may be a cell selected after a failed re-establishment procedure and after a transition from RRC_Connected mode to the RRC_IDLE mode. A re-establishment cell may comprise the cell that is selected for a successful re-establishment

In step 507, the wireless device logs an indication of whether the reconnect cell or re-establishment cell selected after the radio link failure was a candidate cell for the successful handover in a radio link failure (RLF) report.

In step 508 of FIG. 5, the wireless device transmits the RLF report to the network.

When the network receives the RLF report, the network may transmit the RLF report to the source base station of the successful handover. The source base station may then adjust parameters (e.g. moility parameters) associated with the handover type. The source base station may also, responsive to the re-establishment cell or reconnect cell not being a candidate cell for the successful handover, add the re-establishment cell to a list of candidate cells for conditional handover.

The proposed method is applicable to both intra-RAT and inter-RAT scenarios and their related inter-RAT and Intra-RAT handovers, inter-RAT and Intra-RAT reconfiguration with sync as well as inter-RAT and Intra-RAT SCG change procedure.

### Example Implementation

The following exemplifies how the list of RLF reports including conditional handover information can be captured e.g., as part of ASN.1 of 3GPP TS 38.331 v16.2.1. The changes are shown in bold.

****************************************************************************************************************

The UE shall determine the content in the VarRLF-Report as follows:
1> clear the information included in VarRLF-Report, if any;
1> set the plmn-IdentityList to include the list of EPLM Ns stored by the UE (i.e. includes the RPLMN);
1> set the measResultLastServCell to include the cell level RSRP, RSRQ and the available SINR, of the source PCell (in case HO failure) or PCell (in case RLF) based on the available SSB and CSI-RS measurements collected up to the moment the UE detected failure;
1> if the SS/PBCH block-based measurement quantities are available:
   2> set the rsIndexResults in measResultLastServCell to include all the available measurement quantities of the source PCell (in case HO failure) or PCell (in case RLF), ordered such that the highest SS/PBCH block RSRP is listed first if SS/PBCH block RSRP measurement results are available, otherwise the highest SS/PBCH block RSRQ is listed first if SS/PBCH block RSRQ measurement results are available, otherwise the highest SS/PBCH block SINR is listed first, based on the available SS/PBCH block based measurements collected up to the moment the UE detected failure;
1> if the CSI-RS based measurement quantities are available:
   2> set the rsIndexResults in measResultLastServCell to include all the available measurement quantities of the source PCell (in case HO failure) or PCell (in case RLF), ordered such that the highest CSI-RS RSRP is listed first if CSI-RS RSRP measurement results are available, otherwise the highest CSI-RS RSRQ is listed first if CSI-RS RSRQ measurement results are available, otherwise the highest CSI-RS SINR is listed first, based on the available CSI-RS based measurements collected up to the moment the UE detected failure;
1> set the ssbRLMConfigBitmap and/or csi-rsRLMConfigBitmap in measResultLastServCell to include the radio link monitoring configuration of the source PCell (in case HO failure) or PCell (in case RLF);
1> for each of the configured measObjectNR in which measurements are available:
   2> if the SS/PBCH block-based measurement quantities are available:
      3> set the measResultListNR in measResultNeighCells to include all the available measurement quantities of the best measured cells, other than the source PCell (in case HO failure) or PCell (in case RLF), ordered such that the cell with highest SS/PBCH block RSRP is listed first if SS/PBCH block RSRP measurement results are available, otherwise the cell with highest SS/PBCH block RSRQ is listed first if SS/PBCH block RSRQ measurement results are available, otherwise the cell with highest SS/PBCH block SINR is listed first, based on the available SS/PBCH block based measurements collected up to the moment the UE detected failure;
         4> for each neighbour cell included, include the optional fields that are available;
   2> if the CSI-RS based measurement quantities are available:
      3> set the measResultListNR in measResultNeighCells to include all the available measurement quantities of the best measured cells, other than the source PCell, ordered such that the cell with highest CSI-RS RSRP is listed first if CSI-RS RSRP measurement results are available, otherwise the cell with highest CSI-RS RSRQ is listed first if CSI-RS RSRQ measurement results are available, otherwise the cell with highest CSI-RS SINR is listed first, based on the available CSI-RS based measurements collected up to the moment the UE detected radio link failure;
         4> for each neighbour cell included, include the optional fields that are available;
   2> for each of the configured EUTRA frequencies in which measurements are available;
      3> set the measResultListEUTRA in measResultNeighCells to include the best measured cells ordered such that the cell with highest RSRP is listed first if RSRP measurement results are available, otherwise the cell with highest RSRQ is listed first, and based on measurements collected up to the moment the UE detected failure;
         4> for each neighbour cell included, include the optional fields that are available;
NOTE 1: The measured quantities are filtered by the L3 filter as configured in the mobility measurement configuration. The measurements are based on the time domain measurement resource restriction, if configured. Blacklisted cells are not required to be reported.
1> set the c-RNTI to the C-RNTI used in the source PCell (in case HO failure) or PCell (in case RLF);
1> if the failure is detected due to reconfiguration with sync failure as described in 5.3.5.8.3, set the fields in VarRLF-report as follows:
   2> set the connectionFailureType to hof,
   2> if last RRCReconfiguration message including reconfigurationWithSync concerned a failed intra-RAT handover (NR to NR):
      3> set the nrFailedPCellId in failedPCellId to the global cell identity and tracking area code, if available, and otherwise to the physical cell identity and carrier frequency of the target PCell of the failed handover;
   2> else if last MobilityFromNRCommand concerned a failed inter-RAT handover from NR to E-UTRA and if the UE supports Radio Link Failure Report for Inter-RAT MRO (NR to EUTRA):
      3> set the eutraFailedPCellId in failedPCellId to the global cell identity and tracking area code, if available, and otherwise to the physical cell identity and carrier frequency of the target PCell of the failed handover;
   2> include nrPreviousCell in previousPCellId and set it to the global cell identity and tracking area code of the PCell where the last RRCReconfiguration message including reconfigurationWithSync was received;
   2> set the timeConnFailure to the elapsed time since reception of the last RRCReconfiguration message including the reconfigurationWithSync;
1> else if the failure is detected due to radio link failure as described in 5.3.10.3, set the fields in VarRLF-report as follows:
   2> set the connectionFailureType to rlf,
   2> set the rlf-Cause to the trigger for detecting radio link failure in accordance with clause 5.3.10.4;
   2> set the nrFailedPCellId in failedPCellId to the global cell identity and the tracking area code, if available, and otherwise to the physical cell identity and carrier frequency of the PCell where radio link failure is detected;
   2> if an RRCReconfiguration message including the reconfigurationWithSync was received before the connection failure:
      3> if the last RRCReconfiguration message including the reconfigurationWithSync concerned an intra NR handover:
         4> include the nrPreviousCell in previousPCellId and set it to the global cell identity and the tracking area code of the PCell where the last RRCReconfiguration message including reconfigurationWithSync was received;
         4> set the timeConnFailure to the elapsed time since reception of the last RRCReconfiguration message including the reconfigurationWithSync;
         4> if the reconfigurationWithSync is part of conditionalReconfiguration
         5> set reconfigurationWithSyncCHO to true
      3> else if the last RRCReconfiguration message including the reconfigurationWithSync concerned a handover to NR from E-UTRA and if the UE supports Radio Link Failure Report for Inter-RAT MRO:
         4> include the eutraPreviousCell in previousPCellId and set it to the global cell identity and the tracking area code of the E-UTRA PCell where the last RRCReconfiguration message including reconfigurationWithSync was received embedded in E-UTRA RRC message MobilityFromEUTRACommand message as specified in TS 36.331 clause 5.4.3.3;
         4> set the timeConnFailure to the elapsed time since reception of the last RRCReconfiguration message including the reconfigurationWithSync embedded in E-UTRA RRC message MobilityFromEUTRACommand message as specified in TS 36.331 clause 5.4.3.3;
         4> if the reconfigurationWithSync is part of conditionalReconfiguration
         5> set reconfigurationWithSyncCHO to true
1> if connection failure Type is rlf and the rlf-Cause is set to randomAccessProblem or beamFailureRecoyeryFailure; or
1> if connection failure Type is hof:
   2> set the ra-InformationCommon to include the random-access related information as described in subclause 5.7.10.5;
1> if location information is available, set the content of locationInfo as follows:
   2> if available, set the commonLocationInfo to include the detailed location information;
   2> if available, set the bt-LocationInfo in locationInfo to include the Bluetooth measurement results, in order of decreasing RSSI for Bluetooth beacons;
   2> if available, set the wlan-LocationInfo in locationInfo to include the WLAN measurement results, in order of decreasing RSSI for WLAN APs;
   2> if available, set the sensor-LocationInfo in locationInfo to include the sensor measurement results;

The UE may discard the radio link failure information or handover failure information, i.e. release the UE variable VarRLF-Report, 48 hours after the radio link failure/handover failure is detected.
NOTE 2: In this clause, the term ‘handover failure’ has been used to refer to ‘reconfiguration with sync failure’.

6.2.2 Message Definitions

UEInformationResponse message

-- ASN1START
-- TAG-UEINFORMATIONRESPONSE-START

| UEInformationResponse-r16 ::= | | SEQUENCE { |
|---|---|---|
| rrc-TransactionIdentifier | | RRC- |
| TransactionIdentifier, | | |
| criticalExtensions | | CHOICE { |
| ueInformationResponse-r16 | | |
| UEInformationResponse-r16-IEs, | | |
| criticalExtensionsFuture | | SEQUENCE { } |
| } | | |
| } | | |
| UEInformationResponse-r16-IEs ::= | | SEQUENCE { |
| measResultIdleEUTRA-r16 | | MeasResultIdleEUTRA- |
| r16 | OPTIONAL, | |

| | |
|---|---|
| measResultIdleNR-r16 | MeasResultIdleNR-r16 |
| OPTIONAL, | |
| logMeasReport-r16 | LogMeasReport-r16 |
| OPTIONAL, | |
| connEstFailReport-r16 | ConnEstFailReport-r16 |
| OPTIONAL, | |
| ra-ReportList-r16 | RA-ReportList-r16 |
| OPTIONAL, | |
| rlf-Report-r16 | RLF-Report-r16 |
| OPTIONAL, | |
| mobilityHistoryReport-r16 | |
| MobilityHistoryReport-r16 | OPTIONAL, |
| lateNonCriticalExtension | OCTET STRING |
| OPTIONAL, | |
| nonCriticalExtension | SEQUENCE { } |
| OPTIONAL | |
| } | |
| LogMeasReport-r16 ::= | SEQUENCE { |
| absoluteTimeStamp-r16 | AbsoluteTimeInfo-r16, |
| traceReference-r16 | TraceReference-r16, |
| traceRecordingSessionRef-r16 | OCTET STRING (SIZE |
| (2)), | |
| tce-Id-r16 | OCTET STRING (SIZE |
| (1)), | |
| logMeasInfoList-r16 | LogMeasInfoList-r16, |
| logMeasAvailable-r16 | ENUMERATED {true} |
| OPTIONAL, | |
| logMeasAvailableBT-r16 | ENUMERATED {true} |
| OPTIONAL, | |
| logMeasAvailableWLAN-r16 | ENUMERATED {true} |
| OPTIONAL, | |
| ... | |
| } | |
| LogMeasInfoList-r16 ::= | SEQUENCE (SIZE |

(1..maxLogMeasReport-r16)) OF LogMeasInfo-r16

| | |
|---|---|
| LogMeasInfo-r16 ::= | SEQUENCE { |
| locationInfo-r16 | LocationInfo-r16 |
| OPTIONAL, | |
| relativeTimeStamp-r16 | INTEGER (0..7200), |
| servCellIdentity-r16 | CGI-Info-Logging-r16 |
| OPTIONAL, | |
| measResultServingCell-r16 | |
| MeasResultServingCell-r16 | OPTIONAL, |
| measResultNeighCells-r16 | SEQUENCE { |
| measResultNeighCellListNR | |
| MeasResultListLogging2NR-r16 | OPTIONAL, |

measResultNeighCellListEUTRA

| | |
|---|---|
| MeasResultList2EUTRA-r16 | OPTIONAL |
| }, | |
| anyCellSelectionDetected-r16 | ENUMERATED {true} |
| OPTIONAL | |
| } | |
| ConnEstFailReport-r16 ::= | SEQUENCE { |
| measResultFailedCell-r16 | MeasResultFailedCell- |
| r16, | |
| locationInfo-r16 | LocationInfo-r16 |
| OPTIONAL, | |
| measResultNeighCells-r16 | SEQUENCE { |
| measResultNeighCellListNR | |
| MeasResultList2NR-r16 | OPTIONAL, |

measResultNeighCellListEUTRA

| | |
|---|---|
| MeasResultList2EUTRA-r16 | OPTIONAL |
| }, | |
| numberOfConnFail-r16 | INTEGER (1..8), |
| perRAInfoList-r16 | |
| PerRAInfoList-r16, | |
| timeSinceFailure-r16 | TimeSinceFailure-r16, |
| ... | |
| } | |
| MeasResultServingCell-r16 ::= | SEQUENCE { |
| resultsSSB-Cell | MeasQuantityResults, |
| resultsSSB | SEQUENCE{ |
| best-ssb-Index | SSB-Index, |
| best-ssb-Results | |
| MeasQuantityResults, | |
| numberOfGoodSSB | INTEGER |
| (1..maxNrofSSBs-r16) | |
| } | |
| OPTIONAL | |
| } | |
| MeasResultFailedCell-r16 ::= | SEQUENCE { |
| cgi-Info | CGI-Info-Logging-r16, |
| measResult-r16 | SEQUENCE { |
| cellResults-r16 | SEQUENCE{ |
| resultsSSB-Cell-r16 | |
| MeasQuantityResults | |
| }, | |
| rsIndexResults-r16 | SEQUENCE{ |
| resultsSSB-Indexes-r16 | |
| ResultsPerSSB-IndexList | |
| } | |
| } | |
| } | |

RA-ReportList-r16 ::= SEQUENCE (SIZE (1..maxRAReport-r16)) OF

| | |
|---|---|
| RA-Report-r16 | |
| RA-Report-r16 ::= | SEQUENCE { |
| cellId-r16 | CHOICE { |
| cellGlobalId-r16 | CGI-Info-Logging- |
| r16, | |
| pci-arfcn-r16 | SEQUENCE { |
| physCellId-r16 | PhysCellId, |
| carrierFreq-r16 | ARFCN-ValueNR |
| } | |
| }, | |
| ra-InformationCommon-r16 | RA-InformationCommon- |
| r16, | |
| raPurpose-r16 | ENUMERATED |

{accessRelated, beamFailureRecovery, reconfigurationWithSync,
ulUnSynchronized,
schedulingRequestFailure, noPUCCHResourceAvailable,

| | |
|---|---|
| requestForOtherSI, | |
| | spare9, |

spare8, spare7, spare6, spare5, spare4, spare3, spare2,
spare1}
}

| RA-InformationCommon-r16 ::= | | SEQUENCE { |
|---|---|---|
| absoluteFrequencyPointA-r16 | | ARFCN-ValueNR, |
| locationAndBandwidth-r16 | | INTEGER (0..37949), |
| subcarrierSpacing-r16 | | SubcarrierSpacing, |
| msg1-FrequencyStart-r16 | | INTEGER |
| (0..maxNrofPhysicalResourceBlocks-1) | | OPTIONAL, |
| msg1-FrequencyStartCFRA-r16 | | INTEGER |
| (0..maxNrofPhysicalResourceBlocks-1) | | OPTIONAL, |
| msg1-SubcarrierSpacing-r16 | | SubcarrierSpacing |
| OPTIONAL, | | |
| msg1-SubcarrierSpacingCFRA-r16 | | SubcarrierSpacing |
| OPTIONAL, | | |
| msg1-FDM-r16 | | ENUMERATED {one, two, |
| four, eight} | OPTIONAL, | |
| msg1-FDMCFRA-r16 | | ENUMERATED {one, two, |
| four, eight} | OPTIONAL, | |

| | |
|---|---|
| perRAInfoList-r16 | PerRAInfoList-r16 |
| } | |

PerRAInfoList-r16 ::= SEQUENCE (SIZE (1..200)) OF PerRAInfo-

| | |
|---|---|
| r16 | |
| PerRAInfo-r16 ::= | CHOICE { |
| perRASSBInfoList-r16 | PerRASSBInfo-r16, |
| perRACSI-RSInfoList-r16 | PerRACSI-RSInfo-r16 |
| } | |
| PerRASSBInfo-r16 ::= | SEQUENCE { |
| ssb-Index-r16 | SSB-Index, |
| numberOfPreamblesSentOnSSB-r16 | INTEGER (1..200), |
| perRAAttemptInfoList-r16 | PerRAAttemptInfoList- |
| r16 | |
| } | |
| PerRACSI-RSInfo-r16 ::= | SEQUENCE { |
| csi-RS-Index-r16 | CSI-RS-Index, |
| numberOfPreamblesSentOnCSI-RS-r16 | INTEGER (1..200) |
| } | |
| PerRAAttemptInfoList-r16 ::= | SEQUENCE (SIZE (1..200)) |
| OF PerRAAttemptInfo-r16 | |
| PerRAAttemptInfo-r16 ::= | SEQUENCE { |
| contentionDetected-r16 | BOOLEAN |
| OPTIONAL, | |
| dlRSRPAboveThreshold-r16 | BOOLEAN |
| OPTIONAL, | |
| ... | |
| } | |
| RLF-Report-r16 ::= | CHOICE { |
| nr-RLF-Report-r16 | SEQUENCE { |
| measResultLastServCell-r16 | MeasResultRLFNR- |
| r16, | |
| measResultNeighCells-r16 | SEQUENCE { |
| measResultListNR-r16 | |

| | |
|---|---|
| MeasResultList2NR-r16 | OPTIONAL, |

measResultListEUTRA-r16

| | |
|---|---|
| MeasResultList2EUTRA-r16 | OPTIONAL |

| | |
|---|---|
| } | |
| OPTIONAL, | |
| c-RNTI-r16 | RNTI-Value, |
| previousPCellId-r16 | CHOICE { |
| nrPreviousCell-r16 | CGI-Info- |
| Logging-r16, | |
| eutraPreviousCell-r16 | CGI- |
| InfoEUTRALogging | |
| } | |
| OPTIONAL, | |
| failedPCellId-r16 | CHOICE { |
| nrFailedPCellId-r16 | CHOICE { |
| cellGlobalId-r16 | CGI-Info- |
| Logging-r16, | |
| pci-arfcn-r16 | SEQUENCE |
| { | |
| physCellId-r16 | |
| PhysCellId, | |
| carrierFreq-r16 | |
| ARFCN-ValueNR | |
| } | |
| }, | |
| eutraFailedPCellId-r16 | CHOICE { |
| cellGlobalId-r16 | CGI- |
| InfoEUTRALogging, | |
| pci-arfcn-r16 | SEQUENCE { |
| physCellId-r16 | EUTRA- |
| PhysCellId, | |
| carrierFreq-r16 | ARFCN- |
| ValueEUTRA | |
| } | |
| } | |
| }, | |
| reconnectCellId-r16 | CHOICE { |
| nrReconnectCellId-r16 | CGI-Info- |
| Logging-r16, | |
| eutraReconnectCellId-r16 | CGI- |
| InfoEUTRALogging | |
| } | |
| OPTIONAL, | |
| timeUntilReconnection-16 | |
| TimeUntilReconnection-16 | OPTIONAL, |
| reestablishmentCellId-r16 | CGI-Info-Logging- |
| r16 | OPTIONAL, |
| timeConnFailure-r16 | INTEGER (0..1023) |
| OPTIONAL, | |
| timeSinceFailure-r16 | TimeSinceFailure- |

r16,

| | |
|---|---|
| reconfigurationWithSyncCHO-r16 | ENUMERATED |

| | |
|---|---|
| {true,...}, | OPTIONAL, |

| | |
|---|---|
| connectionFailureType-r16 | ENUMERATED {rlf, |
| hof}, | |
| rlf-Cause-r16 | ENUMERATED {t310- |

Expiry, randomAccessProblem, rlc-MaxNumRetx,
beamFailureRecoveryFailure, lbtFailure-r16,

| | |
|---|---|
| | bh- |
| rlfRecoveryFailure, spare2, spare1}, | |
| locationInfo-r16 | LocationInfo-r16 |
| OPTIONAL, | |
| noSuitableCellFound-r16 | ENUMERATED {true} |
| OPTIONAL, | |
| ra-InformationCommon-r16 | RA- |
| InformationCommon-r16 | OPTIONAL, |
| ... | |
| }, | |
| eutra-RLF-Report-r16 | SEQUENCE { |
| failedPCellId-EUTRA | CGI- |
| InfoEUTRALogging, | |
| measResult-RLF-Report-EUTRA-r16 | OCTET STRING, |
| ... | |
| } | |
| } | |
| MeasResultList2NR-r16 ::= | SEQUENCE(SIZE |
| (1..maxFreq)) OF MeasResult2NR-r16 | |
| MeasResultList2EUTRA-r16 ::= | SEQUENCE(SIZE |

(1..maxFreq)) OF MeasResult2EUTRA-r16

| | |
|---|---|
| MeasResult2NR-r16 ::= | SEQUENCE { |
| ssbFrequency-r16 | ARFCN-ValueNR |
| OPTIONAL, | |
| refFreqCSI-RS-r16 | ARFCN-ValueNR |
| OPTIONAL, | |
| measResultList-r16 | MeasResultListNR |
| } | |
| MeasResultListLogging2NR-r16 ::= | SEQUENCE(SIZE |

(1..maxFreq)) OF MeasResultLogging2NR-r16

| | |
|---|---|
| MeasResultLogging2NR-r16 ::= | SEQUENCE { |
| carrierFreq-r16 | ARFCN-ValueNR, |
| measResultListLoggingNR-r16 | |
| MeasResultListLoggingNR-r16 | |
| } | |
| MeasResultListLoggingNR-r16 ::= | SEQUENCE (SIZE |

(1..maxCellReport)) OF MeasResultLoggingNR-r16

| | |
|---|---|
| MeasResultLoggingNR-r16 :::= | SEQUENCE { |
| physCellId-r16 | PhysCellId, |
| resultsSSB-Cell-r16 | MeasQuantityResults, |
| numberOfGoodSSB-r16 | INTEGER |
| (1..maxNrofSSBs-r16) OPTIONAL | |
| } | |
| MeasResult2EUTRA-r16 ::= | SEQUENCE { |
| carrierFreq-r16 | ARFCN-ValueEUTRA, |
| measResultList-r16 | MeasResultListEUTRA |
| } | |
| MeasResultRLFNR-r16 ::= | SEQUENCE { |
| measResult-r16 | SEQUENCE { |
| cellResults-r16 | SEQUENCE { |
| resultsSSB-Cell-r16 | |
| MeasQuantityResults | OPTIONAL, |
| resultsCSI-RS-Cell-r16 | |
| MeasQuantityResults | OPTIONAL |
| }, | |
| rsIndexResults-r16 | SEQUENCE{ |
| resultsSSB-Indexes-r16 | |
| ResultsPerSSB-IndexList | OPTIONAL, |
| ssbRLMConfigBitmap-r16 | BIT STRING |
| (SIZE (64)) | OPTIONAL, |
| resultsCSI-RS-Indexes-r16 | OPTIONAL, |
| ResultsPerCSI-RS-IndexList | BIT STRING |
| csi-rsRLMConfigBitmap-r16 | |
| (SIZE (96)) | OPTIONAL, |

}

OPTIONAL
}
}

TimeSinceFailure-r16 ::= INTEGER (0..172800)
MobilityHistoryReport-r16 ::= VisitedCellInfoList-r16
TimeUntilReconnection-16 ::= INTEGER (0..172800)

RLF-Report field descriptions

connectionFailureType
This field is used to indicate whether the connection failure
is due to radio link failure or handover failure.
csi-rsRLMConfigBitmap
This field is used to indicate the CSI-RS indexes that are also
part of the RLM configurations.
c-RNTI
This field indicates the C-RNTI used in the PCell upon detecting radio
link failure or the C-RNTI used in the source PCell upon handover failure.
failedPCellId
This field is used to indicate the PCell in which RLF is detected or the
target PCell of the failed handover. For intra-NR handover nrFailedPCellId
is included and for the handover from NR to EUTRA eutraFailedPCellId is
included. The UE sets the ARFCN according to the frequency band used for
transmission/reception when the failure occurred.
failedPCellId-EUTRA
This field is used to indicate the PCell in which RLF is detected or the
source PCell of the failed handover in an E-UTRA RLF report.
measResultListEUTRA
This field refers to the last measurement results taken in the neighboring
EUTRA Cells, when the radio link failure or handover failure happened.
measResultListNR
This field refers to the last measurement results taken in the neighboring
NR Cells, when the radio link failure or handover failure happened.
measResultServCell
This field refers to the log measurement results taken in the Serving cell.
measResult-RLF-Report-EUTRA
Includes the E-UTRA RLF-Report-r9 IE as specified in TS 36.331 [10].
noSuitableCellFound
This field is set by the UE when the T311 expires.
previousPCellId
This field is used to indicate the source PCell of the last handover (source
PCell when the last RRCReconfiguration message including reconfigurationWithSync
was received). For intra-NR handover nrPreviousCell is included and for the
handover from EUTRA to NR eutraPreviousCell is included.
reconnectCellId
This field is used to indicate the cell in which the UE comes back to conne
after connection failure and after failing to perform reestablishment. If
the UE comes back to RRC CONNECTED in an NR cell then nrReconnectCellID is
included and if the UE comes back to RRC CONNECTED in an LTE cell then
eutraReconnectCellID is included
reconfigurationWithSyncCHO
This field is used to indicate the reconfigurationWith Sync was related to
a CHO. This field is set to true when an RLF occures after a successful CHO
execution.
reestablishmentCellId
This field is used to indicate the cell in which the re-establishment attempt
was made after connection failure.
rlf-Cause
This field is used to indicate the cause of the last radio link failure that
was detected. In case of handover failure information reporting (i.e., the
connectionFailure Type is set to ‘hof’), the UE isallowed to set this
field to any value.
ssbRLMConfigBitmap
This field is used to indicate the SS/PBCH block indexes that are also part
of the RLM configurations.
timeConnFailure
This field is used to indicate the time elapsed since the last HO initialization
until connection failure. Actual value = field value * 100 ms. The maximum
value 1023 means 102.3 s or longer.
timeSinceFailure
This field is used to indicate the time that elapsed since the connection
(radio link or handover) failure. Value in seconds. The maximum value 172800
means 172800 s or longer.
timeUntilReconnection
This field is used to indicate the time that elapsed between the connection
(radio link or handover) failure and the next time the UE comes to RRC
CONNECTED in an NR or EUTRA cell. Value in seconds. The maximum value 172800
means 172800 s or longer.

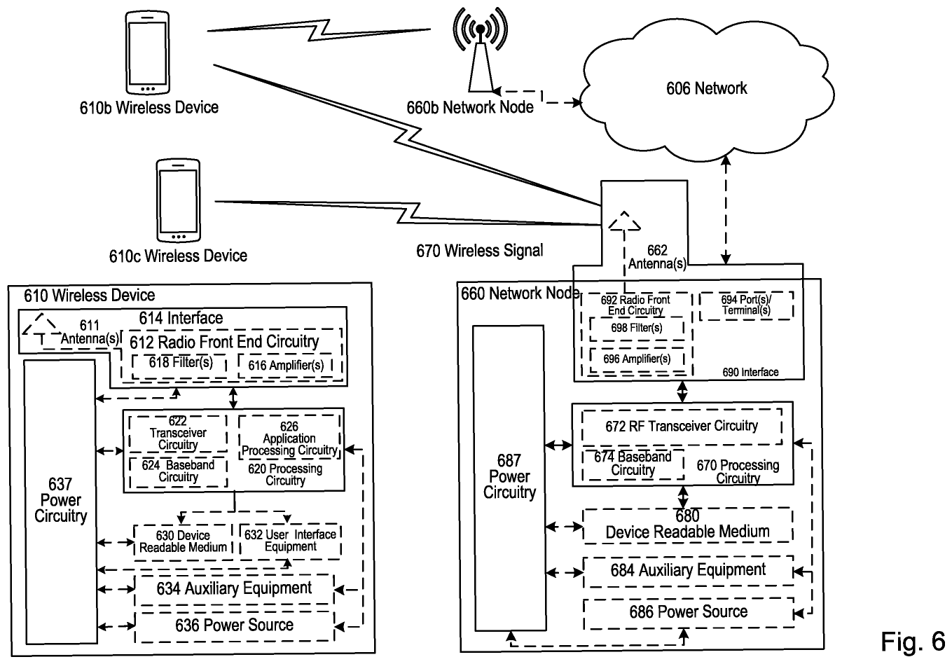

Although the subject matter described herein may be implemented in any appropriate type of system using any suitable components, the embodiments disclosed herein are described in relation to a wireless network, such as the example wireless network illustrated in FIG. 6. For simplicity, the wireless network of FIG. 6 only depicts network 606, network nodes 660 and 660b, and WDs 610, 610b, and 610c. In practice, a wireless network may further include any additional elements suitable to support communication between wireless devices or between a wireless device and another communication device, such as a landline telephone, a service provider, or any other network node or end device. Of the illustrated components, network node 660 and wireless device (WD) 610 are depicted with additional detail. The network node 660 may perform the method as described above with reference to FIG. 3. The wireless device 610 may perform the method as described above with reference to FIGS. 3 and 5. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 606 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 660 and WD 610 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 6, network node 660 includes processing circuitry 670, device readable medium 680, interface 690, auxiliary equipment 684, power source 686, power circuitry 687, and antenna 662. Although network node 660 illustrated in the example wireless network of FIG. 6 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 660 are depicted as single boxes located within a larger box, or nested within multiple boxes, in practice, a network node may comprise multiple different physical components that make up a single illustrated component (e.g., device readable medium 680 may comprise multiple separate hard drives as well as multiple RAM modules).

Similarly, network node 660 may be composed of multiple physically separate components (e.g., a NodeB component and a RNC component, or a BTS component and a BSC component, etc.), which may each have their own respective components. In certain scenarios in which network node 660 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 660 may be configured to support multiple radio access technologies (RATs). In such embodiments, some components may be duplicated (e.g., separate device readable medium 680 for the different RATs) and some components may be reused (e.g., the same antenna 662 may be shared by the RATs). Network node 660 may also include multiple sets of the various illustrated components for different wireless technologies integrated into network node 660, such as, for example, GSM, WCDMA, LTE, NR, WiFi, or Bluetooth wireless technologies. These wireless technologies may be integrated into the same or different chip or set of chips and other components within network node 660.

Processing circuitry 670 is configured to perform any determining, calculating, or similar operations (e.g., certain obtaining operations) described herein as being provided by a network node. These operations performed by processing circuitry 670 may include processing information obtained by processing circuitry 670 by, for example, converting the obtained information into other information, comparing the obtained information or converted information to information stored in the network node, and/or performing one or more operations based on the obtained information or converted information, and as a result of said processing making a determination.

Processing circuitry 670 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 660 components, such as device readable medium 680, network node 660 functionality. For example, processing circuitry 670 may execute instructions stored in device readable medium 680 or in memory within processing circuitry 670. Such functionality may include providing any of the various wireless features, functions, or benefits discussed herein. In some embodiments, processing circuitry 670 may include a system on a chip (SOC).

In some embodiments, processing circuitry 670 may include one or more of radio frequency (RF) transceiver circuitry 672 and baseband processing circuitry 674. In some embodiments, radio frequency (RF) transceiver circuitry 672 and baseband processing circuitry 674 may be on separate chips (or sets of chips), boards, or units, such as radio units and digital units. In alternative embodiments, part or all of RF transceiver circuitry 672 and baseband processing circuitry 674 may be on the same chip or set of chips, boards, or units

In certain embodiments, some or all of the functionality described herein as being provided by a network node, base station, eNB or other such network device may be performed by processing circuitry 670 executing instructions stored on device readable medium 680 or memory within processing circuitry 670. In alternative embodiments, some or all of the functionality may be provided by processing circuitry 670 without executing instructions stored on a separate or discrete device readable medium, such as in a hard-wired manner. In any of those embodiments, whether executing instructions stored on a device readable storage medium or not, processing circuitry 670 can be configured to perform the described functionality. The benefits provided by such functionality are not limited to processing circuitry 670 alone or to other components of network node 660, but are enjoyed by network node 660 as a whole, and/or by end users and the wireless network generally.

Device readable medium 680 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 670. Device readable medium 680 may store any suitable instructions, data or information, including a computer program, software, an application including one or more of logic, rules, code, tables, etc. and/or other instructions capable of being executed by processing circuitry 670 and, utilized by network node 660. Device readable medium 680 may be used to store any calculations made by processing circuitry 670 and/or any data received via interface 690. In some embodiments, processing circuitry 670 and device readable medium 680 may be considered to be integrated.

Interface 690 is used in the wired or wireless communication of signalling and/or data between network node 660, network 606, and/or WDs 610. As illustrated, interface 690 comprises port(s)/terminal(s) 694 to send and receive data, for example to and from network 606 over a wired connection. Interface 690 also includes radio front end circuitry 692 that may be coupled to, or in certain embodiments a part of, antenna 662. Radio front end circuitry 692 comprises filters 698 and amplifiers 696. Radio front end circuitry 692 may be connected to antenna 662 and processing circuitry 670. Radio front end circuitry may be configured to condition signals communicated between antenna 662 and processing circuitry 670. Radio front end circuitry 692 may receive digital data that is to be sent out to other network nodes or WDs via a wireless connection. Radio front end circuitry 692 may convert the digital data into a radio signal having the appropriate channel and bandwidth parameters using a combination of filters 698 and/or amplifiers 696. The radio signal may then be transmitted via antenna 662. Similarly, when receiving data, antenna 662 may collect radio signals which are then converted into digital data by radio front end circuitry 692. The digital data may be passed to processing circuitry 670. In other embodiments, the interface may comprise different components and/or different combinations of components.

In certain alternative embodiments, network node 660 may not include separate radio front end circuitry 692, instead, processing circuitry 670 may comprise radio front end circuitry and may be connected to antenna 662 without separate radio front end circuitry 692. Similarly, in some embodiments, all or some of RF transceiver circuitry 672 may be considered a part of interface 690. In still other embodiments, interface 690 may include one or more ports or terminals 694, radio front end circuitry 692, and RF transceiver circuitry 672, as part of a radio unit (not shown), and interface 690 may communicate with baseband processing circuitry 674, which is part of a digital unit (not shown).

Antenna 662 may include one or more antennas, or antenna arrays, configured to send and/or receive wireless signals. Antenna 662 may be coupled to radio front end circuitry 690 and may be any type of antenna capable of transmitting and receiving data and/or signals wirelessly. In some embodiments, antenna 662 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 662 may be separate from network node 660 and may be connectable to network node 660 through an interface or port.

Antenna 662, interface 690, and/or processing circuitry 670 may be configured to perform any receiving operations and/or certain obtaining operations described herein as being performed by a network node. Any information, data and/or signals may be received from a wireless device, another network node and/or any other network equipment. Similarly, antenna 662, interface 690, and/or processing circuitry 670 may be configured to perform any transmitting operations described herein as being performed by a network node. Any information, data and/or signals may be transmitted to a wireless device, another network node and/or any other network equipment.

Power circuitry 687 may comprise, or be coupled to, power management circuitry and is configured to supply the components of network node 660 with power for performing the functionality described herein. Power circuitry 687 may receive power from power source 686. Power source 686 and/or power circuitry 687 may be configured to provide power to the various components of network node 660 in a form suitable for the respective components (e.g., at a voltage and current level needed for each respective component). Power source 686 may either be included in, or external to, power circuitry 687 and/or network node 660. For example, network node 660 may be connectable to an external power source (e.g., an electricity outlet) via an input circuitry or interface such as an electrical cable, whereby the external power source supplies power to power circuitry 687. As a further example, power source 686 may comprise a source of power in the form of a battery or battery pack which is connected to, or integrated in, power circuitry 687. The battery may provide backup power should the external power source fail. Other types of power sources, such as photovoltaic devices, may also be used.

Alternative embodiments of network node 660 may include additional components beyond those shown in FIG. 6 that may be responsible for providing certain aspects of the network node's functionality, including any of the functionality described herein and/or any functionality necessary to support the subject matter described herein. For example, network node 660 may include user interface equipment to allow input of information into network node 660 and to allow output of information from network node 660. This may allow a user to perform diagnostic, maintenance, repair, and other administrative functions for network node 660.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc.. A WD may support device-to-device (D2D) communication, for example by implementing a 3GPP standard for sidelink communication, vehicle-to-vehicle (V2V), vehicle-to-infrastructure (V21), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 610 includes antenna 611, interface 614, processing circuitry 620, device readable medium 630, user interface equipment 632, auxiliary equipment 634, power source 636 and power circuitry 637. WD 610 may include multiple sets of one or more of the illustrated components for different wireless technologies supported by WD 610, such as, for example, GSM, WCDMA, LTE, NR, WiFi, WiMAX, or Bluetooth wireless technologies, just to mention a few. These wireless technologies may be integrated into the same or different chips or set of chips as other components within WD 610.

Antenna 611 may include one or more antennas or antenna arrays, configured to send and/or receive wireless signals, and is connected to interface 614. In certain alternative embodiments, antenna 611 may be separate from WD 610 and be connectable to WD 610 through an interface or port. Antenna 611, interface 614, and/or processing circuitry 620 may be configured to perform any receiving or transmitting operations described herein as being performed by a WD. Any information, data and/or signals may be received from a network node and/or another WD. In some embodiments, radio front end circuitry and/or antenna 611 may be considered an interface.

As illustrated, interface 614 comprises radio front end circuitry 612 and antenna 611. Radio front end circuitry 612 comprise one or more filters 618 and amplifiers 616. Radio front end circuitry 614 is connected to antenna 611 and processing circuitry 620, and is configured to condition signals communicated between antenna 611 and processing circuitry 620. Radio front end circuitry 612 may be coupled to or a part of antenna 611. In some embodiments, WD 610 may not include separate radio front end circuitry 612; rather, processing circuitry 620 may comprise radio front end circuitry and may be connected to antenna 611. Similarly, in some embodiments, some or all of RF transceiver circuitry 622 may be considered a part of interface 614. Radio front end circuitry 612 may receive digital data that is to be sent out to other network nodes or WDs via a wireless connection. Radio front end circuitry 612 may convert the digital data into a radio signal having the appropriate channel and bandwidth parameters using a combination of filters 618 and/or amplifiers 616. The radio signal may then be transmitted via antenna 611. Similarly, when receiving data, antenna 611 may collect radio signals which are then converted into digital data by radio front end circuitry 612. The digital data may be passed to processing circuitry 620. In other embodiments, the interface may comprise different components and/or different combinations of components.

Processing circuitry 620 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 610 components, such as device readable medium 630, WD 610 functionality. Such functionality may include providing any of the various wireless features or benefits discussed herein. For example, processing circuitry 620 may execute instructions stored in device readable medium 630 or in memory within processing circuitry 620 to provide the functionality disclosed herein.

As illustrated, processing circuitry 620 includes one or more of RF transceiver circuitry 622, baseband processing circuitry 624, and application processing circuitry 626. In other embodiments, the processing circuitry may comprise different components and/or different combinations of components. In certain embodiments processing circuitry 620 of WD 610 may comprise a SOC. In some embodiments, RF transceiver circuitry 622, baseband processing circuitry 624, and application processing circuitry 626 may be on separate chips or sets of chips. In alternative embodiments, part or all of baseband processing circuitry 624 and application processing circuitry 626 may be combined into one chip or set of chips, and RF transceiver circuitry 622 may be on a separate chip or set of chips. In still alternative embodiments, part or all of RF transceiver circuitry 622 and baseband processing circuitry 624 may be on the same chip or set of chips, and application processing circuitry 626 may be on a separate chip or set of chips. In yet other alternative embodiments, part or all of RF transceiver circuitry 622, baseband processing circuitry 624, and application processing circuitry 626 may be combined in the same chip or set of chips. In some embodiments, RF transceiver circuitry 622 may be a part of interface 614. RF transceiver circuitry 622 may condition RF signals for processing circuitry 620.

In certain embodiments, some or all of the functionality described herein as being performed by a WD may be provided by processing circuitry 620 executing instructions stored on device readable medium 630, which in certain embodiments may be a computer-readable storage medium. In alternative embodiments, some or all of the functionality may be provided by processing circuitry 620 without executing instructions stored on a separate or discrete device readable storage medium, such as in a hard-wired manner. In any of those particular embodiments, whether executing instructions stored on a device readable storage medium or not, processing circuitry 620 can be configured to perform the described functionality. The benefits provided by such functionality are not limited to processing circuitry 620 alone or to other components of WD 610, but are enjoyed by WD 610 as a whole, and/or by end users and the wireless network generally.

Processing circuitry 620 may be configured to perform any determining, calculating, or similar operations (e.g., certain obtaining operations) described herein as being performed by a WD. These operations, as performed by processing circuitry 620, may include processing information obtained by processing circuitry 620 by, for example, converting the obtained information into other information, comparing the obtained information or converted information to information stored by WD 610, and/or performing one or more operations based on the obtained information or converted information, and as a result of said processing making a determination.

Device readable medium 630 may be operable to store a computer program, software, an application including one or more of logic, rules, code, tables, etc. and/or other instructions capable of being executed by processing circuitry 620. Device readable medium 630 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 620. In some embodiments, processing circuitry 620 and device readable medium 630 may be considered to be integrated.

User interface equipment 632 may provide components that allow for a human user to interact with WD 610. Such interaction may be of many forms, such as visual, audial, tactile, etc. User interface equipment 632 may be operable to produce output to the user and to allow the user to provide input to WD 610. The type of interaction may vary depending on the type of user interface equipment 632 installed in WD 610. For example, if WD 610 is a smart phone, the interaction may be via a touch screen; if WD 610 is a smart meter, the interaction may be through a screen that provides usage (e.g., the number of gallons used) or a speaker that provides an audible alert (e.g., if smoke is detected). User interface equipment 632 may include input interfaces, devices and circuits, and output interfaces, devices and circuits. User interface equipment 632 is configured to allow input of information into WD 610, and is connected to processing circuitry 620 to allow processing circuitry 620 to process the input information. User interface equipment 632 may include, for example, a microphone, a proximity or other sensor, keys/buttons, a touch display, one or more cameras, a USB port, or other input circuitry. User interface equipment 632 is also configured to allow output of information from WD 610, and to allow processing circuitry 620 to output information from WD 610. User interface equipment 632 may include, for example, a speaker, a display, vibrating circuitry, a USB port, a headphone interface, or other output circuitry. Using one or more input and output interfaces, devices, and circuits, of user interface equipment 632, WD 610 may communicate with end users and/or the wireless network, and allow them to benefit from the functionality described herein.

Auxiliary equipment 634 is operable to provide more specific functionality which may not be generally performed by WDs. This may comprise specialized sensors for doing measurements for various purposes, interfaces for additional types of communication such as wired communications etc. The inclusion and type of components of auxiliary equipment 634 may vary depending on the embodiment and/or scenario.

Power source 636 may, in some embodiments, be in the form of a battery or battery pack. Other types of power sources, such as an external power source (e.g., an electricity outlet), photovoltaic devices or power cells, may also be used. WD 610 may further comprise power circuitry 637 for delivering power from power source 636 to the various parts of WD 610 which need power from power source 636 to carry out any functionality described or indicated herein. Power circuitry 637 may in certain embodiments comprise power management circuitry. Power circuitry 637 may additionally or alternatively be operable to receive power from an external power source; in which case WD 610 may be connectable to the external power source (such as an electricity outlet) via input circuitry or an interface such as an electrical power cable. Power circuitry 637 may also in certain embodiments be operable to deliver power from an external power source to power source 636. This may be, for example, for the charging of power source 636. Power circuitry 637 may perform any formatting, converting, or other modification to the power from power source 636 to make the power suitable for the respective components of WD 610 to which power is supplied.

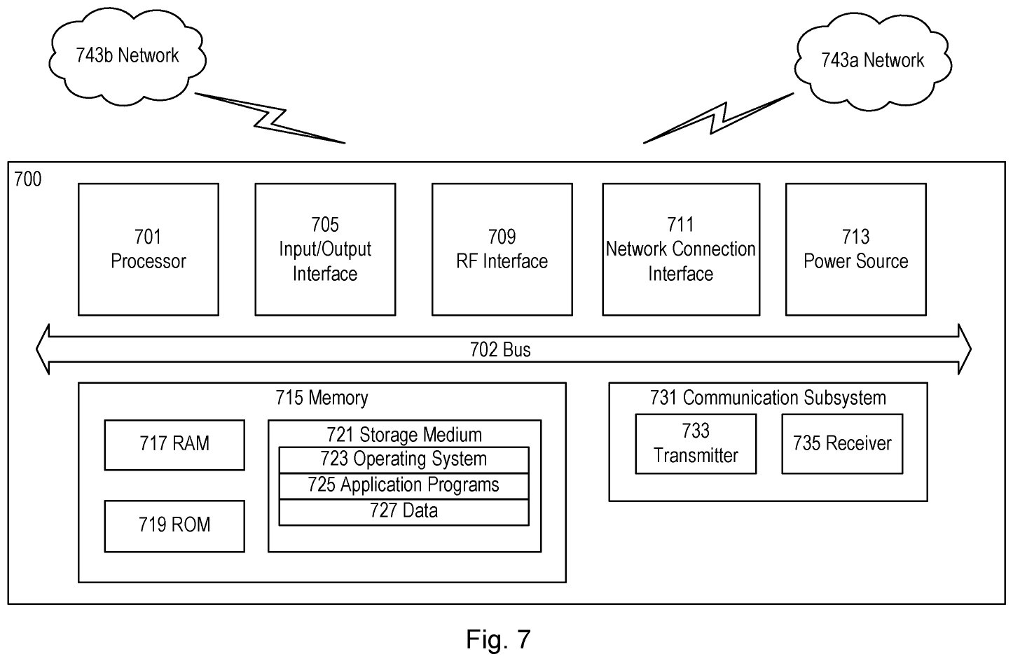

7FIG. 7 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 700 may be any UE identified by the 3^{rd} Generation Partnership Project (3GPP), including a NB-IoT UE, a machine type communication (MTC) UE, and/or an enhanced MTC (eMTC) UE. UE 700, as illustrated in FIG. 7, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 7 is a UE, the components discussed herein are equally applicable to a WD, and vice-versa.

In FIG. 7, UE 700 includes processing circuitry 701 that is operatively coupled to input/output interface 705, radio frequency (RF) interface 709, network connection interface 711, memory 715 including random access memory (RAM) 717, read-only memory (ROM) 719, and storage medium 721 or the like, communication subsystem 731, power source 733, and/or any other component, or any combination thereof. Storage medium 721 includes operating system 723, application program 725, and data 727. In other embodiments, storage medium 721 may include other similar types of information. Certain UEs may utilize all of the components shown in FIG. 7, or only a subset of the components. The level of integration between the components may vary from one UE to another UE. Further, certain UEs may contain multiple instances of a component, such as multiple processors, memories, transceivers, transmitters, receivers, etc.

In FIG. 7, processing circuitry 701 may be configured to process computer instructions and data. Processing circuitry 701 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 701 may include two central processing units (CPUs). Data may be information in a form suitable for use by a computer.

In the depicted embodiment, input/output interface 705 may be configured to provide a communication interface to an input device, output device, or input and output device. UE 700 may be configured to use an output device via input/output interface 705. An output device may use the same type of interface port as an input device. For example, a USB port may be used to provide input to and output from UE 700. The output device may be a speaker, a sound card, a video card, a display, a monitor, a printer, an actuator, an emitter, a smartcard, another output device, or any combination thereof. UE 700 may be configured to use an input device via input/output interface 705 to allow a user to capture information into UE 700. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 7, RF interface 709 may be configured to provide a communication interface to RF components such as a transmitter, a receiver, and an antenna. Network connection interface 711 may be configured to provide a communication interface to network 743a. Network 743a may encompass wired and/or wireless networks such as a local-area network (LAN), a wide-area network (WAN), a computer network, a wireless network, a telecommunications network, another like network or any combination thereof. For example, network 743a may comprise a Wi-Fi network. Network connection interface 711 may be configured to include a receiver and a transmitter interface used to communicate with one or more other devices over a communication network according to one or more communication protocols, such as Ethernet, TCP/IP, SONET, ATM, or the like. Network connection interface 711 may implement receiver and transmitter functionality appropriate to the communication network links (e.g., optical, electrical, and the like). The transmitter and receiver functions may share circuit components, software or firmware, or alternatively may be implemented separately.

RAM 717 may be configured to interface via bus 702 to processing circuitry 701 to provide storage or caching of data or computer instructions during the execution of software programs such as the operating system, application programs, and device drivers. ROM 719 may be configured to provide computer instructions or data to processing circuitry 701. For example, ROM 719 may be configured to store invariant low-level system code or data for basic system functions such as basic input and output (I/O), startup, or reception of keystrokes from a keyboard that are stored in a non-volatile memory. Storage medium 721 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 721 may be configured to include operating system 723, application program 725 such as a web browser application, a widget or gadget engine or another application, and data file 727. Storage medium 721 may store, for use by UE 700, any of a variety of various operating systems or combinations of operating systems.

Storage medium 721 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 721 may allow UE 700 to access computer-executable instructions, application programs or the like, stored on transitory or non-transitory memory media, to off-load data, or to upload data. An article of manufacture, such as one utilizing a communication system may be tangibly embodied in storage medium 721, which may comprise a device readable medium.

In FIG. 7, processing circuitry 701 may be configured to communicate with network 743b using communication subsystem 731. Network 743a and network 743b may be the same network or networks or different network or networks. Communication subsystem 731 may be configured to include one or more transceivers used to communicate with network 743b. For example, communication subsystem 731 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 733 and/or receiver 735 to implement transmitter or receiver functionality, respectively, appropriate to the RAN links (e.g., frequency allocations and the like). Further, transmitter 733 and receiver 735 of each transceiver may share circuit components, software or firmware, or alternatively may be implemented separately.

In the illustrated embodiment, the communication functions of communication subsystem 731 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 731 may include cellular communication, Wi-Fi communication, Bluetooth communication, and GPS communication. Network 743b may encompass wired and/or wireless networks such as a local-area network (LAN), a wide-area network (WAN), a computer network, a wireless network, a telecommunications network, another like network or any combination thereof. For example, network 743b may be a cellular network, a Wi-Fi network, and/or a near-field network. Power source 713 may be configured to provide alternating current (AC) or direct current (DC) power to components of UE 700.

The features, benefits and/or functions described herein may be implemented in one of the components of UE 700 or partitioned across multiple components of UE 700. Further, the features, benefits, and/or functions described herein may be implemented in any combination of hardware, software or firmware. In one example, communication subsystem 731 may be configured to include any of the components described herein. Further, processing circuitry 701 may be configured to communicate with any of such components over bus 702. In another example, any of such components may be represented by program instructions stored in memory that when executed by processing circuitry 701 perform the corresponding functions described herein. In another example, the functionality of any of such components may be partitioned between processing circuitry 701 and communication subsystem 731. In another example, the non-computationally intensive functions of any of such components may be implemented in software or firmware and the computationally intensive functions may be implemented in hardware.

8FIG. 8 is a schematic block diagram illustrating a virtualization environment 800 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 800 hosted by one or more of hardware nodes 830. Further, in embodiments in which the virtual node is not a radio access node or does not require radio connectivity (e.g., a core network node), then the network node may be entirely virtualized.

The functions may be implemented by one or more applications 820 (which may alternatively be called software instances, virtual appliances, network functions, virtual nodes, virtual network functions, etc.) operative to implement some of the features, functions, and/or benefits of some of the embodiments disclosed herein. Applications 820 are run in virtualization environment 800 which provides hardware 830 comprising processing circuitry 860 and memory 890. Memory 890 contains instructions 895 executable by processing circuitry 860 whereby application 820 is operative to provide one or more of the features, benefits, and/or functions disclosed herein.

Virtualization environment 800, comprises general-purpose or special-purpose network hardware devices 830 comprising a set of one or more processors or processing circuitry 860, which may be commercial off-the-shelf (COTS) processors, dedicated Application Specific Integrated Circuits (ASICs), or any other type of processing circuitry including digital or analog hardware components or special purpose processors. Each hardware device may comprise memory 890-1 which may be non-persistent memory for temporarily storing instructions 895 or software executed by processing circuitry 860. Each hardware device may comprise one or more network interface controllers (NICs) 870, also known as network interface cards, which include physical network interface 880. Each hardware device may also include non-transitory, persistent, machine-readable storage media 890-2 having stored therein software 895 and/or instructions executable by processing circuitry 860. Software 895 may include any type of software including software for instantiating one or more virtualization layers 850 (also referred to as hypervisors), software to execute virtual machines 840 as well as software allowing it to execute functions, features and/or benefits described in relation with some embodiments described herein.

Virtual machines 840, comprise virtual processing, virtual memory, virtual networking or interface and virtual storage, and may be run by a corresponding virtualization layer 850 or hypervisor. Different embodiments of the instance of virtual appliance 820 may be implemented on one or more of virtual machines 840, and the implementations may be made in different ways.

During operation, processing circuitry 860 executes software 895 to instantiate the hypervisor or virtualization layer 850, which may sometimes be referred to as a virtual machine monitor (VMM). Virtualization layer 850 may present a virtual operating platform that appears like networking hardware to virtual machine 840.

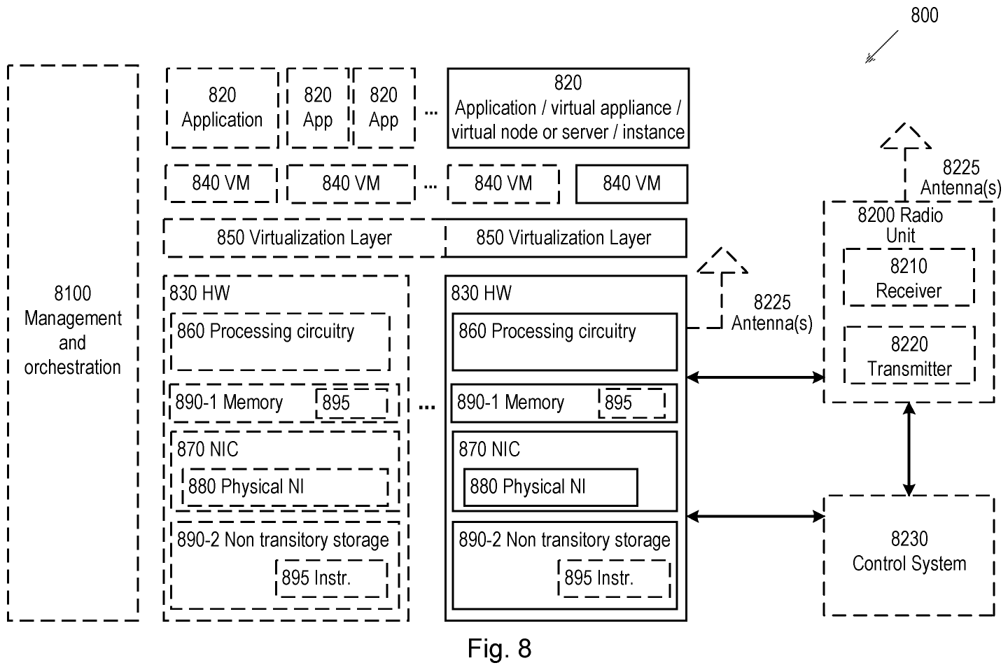

As shown in FIG. 8, hardware 830 may be a standalone network node with generic or specific components. Hardware 830 may comprise antenna 8225 and may implement some functions via virtualization. Alternatively, hardware 830 may be part of a larger cluster of hardware (e.g. such as in a data center or customer premise equipment (CPE)) where many hardware nodes work together and are managed via management and orchestration (MANO) 8100, which, among others, oversees lifecycle management of applications 820.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 840 may be a software implementation of a physical machine that runs programs as if they were executing on a physical, non-virtualized machine. Each of virtual machines 840, and that part of hardware 830 that executes that virtual machine, be it hardware dedicated to that virtual machine and/or hardware shared by that virtual machine with others of the virtual machines 840, forms a separate virtual network elements (VNE).

Still in the context of NFV, Virtual Network Function (VNF) is responsible for handling specific network functions that run in one or more virtual machines 840 on top of hardware networking infrastructure 830 and corresponds to application 820 in FIG. 8.

In some embodiments, one or more radio units 8200 that each include one or more transmitters 8220 and one or more receivers 8210 may be coupled to one or more antennas 8225. Radio units 8200 may communicate directly with hardware nodes 830 via one or more appropriate network interfaces and may be used in combination with the virtual components to provide a virtual node with radio capabilities, such as a radio access node or a base station.

In some embodiments, some signalling can be effected with the use of control system 8230 which may alternatively be used for communication between the hardware nodes 830 and radio units 8200.

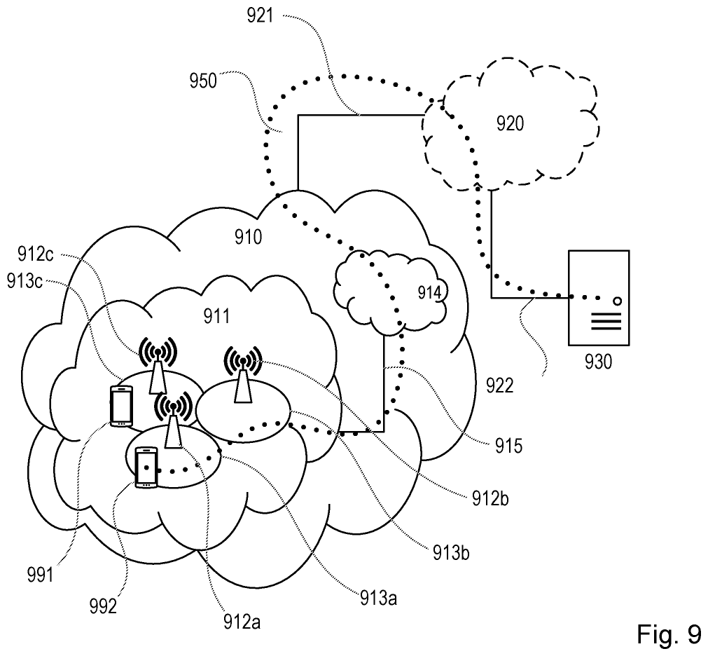

9With reference to FIG. 9, in accordance with an embodiment, a communication system includes telecommunication network 910, such as a 3GPP-type cellular network, which comprises access network 911, such as a radio access network, and core network 914. Access network 911 comprises a plurality of base stations 912a, 912b, 912c, such as NBs, eNBs, gNBs or other types of wireless access points, each defining a corresponding coverage area 913a, 913b, 913c. Each base station 912a, 912b, 912c is connectable to core network 914 over a wired or wireless connection 915. A first UE 991 located in coverage area 913c is configured to wirelessly connect to, or be paged by, the corresponding base station 912c. A second UE 992 in coverage area 913a is wirelessly connectable to the corresponding base station 912a. While a plurality of UEs 991, 992 are illustrated in this example, the disclosed embodiments are equally applicable to a situation where a sole UE is in the coverage area or where a sole UE is connecting to the corresponding base station 912.

Telecommunication network 910 is itself connected to host computer 930, which may be embodied in the hardware and/or software of a standalone server, a cloud-implemented server, a distributed server or as processing resources in a server farm. Host computer 930 may be under the ownership or control of a service provider, or may be operated by the service provider or on behalf of the service provider. Connections 921 and 922 between telecommunication network 910 and host computer 930 may extend directly from core network 914 to host computer 930 or may go via an optional intermediate network 920. Intermediate network 920 may be one of, or a combination of more than one of, a public, private or hosted network; intermediate network 920, if any, may be a backbone network or the Internet; in particular, intermediate network 920 may comprise two or more sub-networks (not shown).

The communication system of FIG. 9 as a whole enables connectivity between the connected UEs 991, 992 and host computer 930. The connectivity may be described as an over-the-top (OTT) connection 950. Host computer 930 and the connected UEs 991, 992 are configured to communicate data and/or signaling via OTT connection 950, using access network 911, core network 914, any intermediate network 920 and possible further infrastructure (not shown) as intermediaries. OTT connection 950 may be transparent in the sense that the participating communication devices through which OTT connection 950 passes are unaware of routing of uplink and downlink communications. For example, base station 912 may not or need not be informed about the past routing of an incoming downlink communication with data originating from host computer 930 to be forwarded (e.g., handed over) to a connected UE 991. Similarly, base station 912 need not be aware of the future routing of an outgoing uplink communication originating from the UE 991 towards the host computer 930.

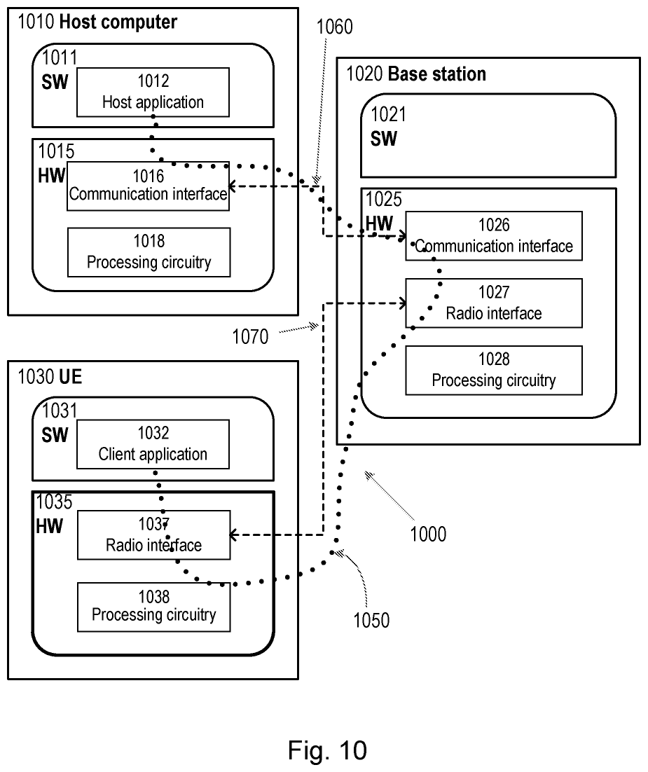

10Example implementations, in accordance with an embodiment, of the UE, base station and host computer discussed in the preceding paragraphs will now be described with reference to FIG. 10. In communication system 1000, host computer 1010 comprises hardware 1015 including communication interface 1016 configured to set up and maintain a wired or wireless connection with an interface of a different communication device of communication system 1000. Host computer 1010 further comprises processing circuitry 1018, which may have storage and/or processing capabilities. In particular, processing circuitry 1018 may comprise one or more programmable processors, application-specific integrated circuits, field programmable gate arrays or combinations of these (not shown) adapted to execute instructions. Host computer 1010 further comprises software 1011, which is stored in or accessible by host computer 1010 and executable by processing circuitry 1018. Software 1011 includes host application 1012. Host application 1012 may be operable to provide a service to a remote user, such as UE 1030 connecting via OTT connection 1050 terminating at UE 1030 and host computer 1010. In providing the service to the remote user, host application 1012 may provide user data which is transmitted using OTT connection 1050.

Communication system 1000 further includes base station 1020 provided in a telecommunication system and comprising hardware 1025 enabling it to communicate with host computer 1010 and with UE 1030. Hardware 1025 may include communication interface 1026 for setting up and maintaining a wired or wireless connection with an interface of a different communication device of communication system 1000, as well as radio interface 1027 for setting up and maintaining at least wireless connection 1070 with UE 1030 located in a coverage area (not shown in FIG. 10) served by base station 1020. Communication interface 1026 may be configured to facilitate connection 1060 to host computer 1010. Connection 1060 may be direct or it may pass through a core network (not shown in FIG. 10) of the telecommunication system and/or through one or more intermediate networks outside the telecommunication system. In the embodiment shown, hardware 1025 of base station 1020 further includes processing circuitry 1028, which may comprise one or more programmable processors, application-specific integrated circuits, field programmable gate arrays or combinations of these (not shown) adapted to execute instructions. Base station 1020 further has software 1021 stored internally or accessible via an external connection.

Communication system 1000 further includes UE 1030 already referred to. Its hardware 1035 may include radio interface 1037 configured to set up and maintain wireless connection 1070 with a base station serving a coverage area in which UE 1030 is currently located. Hardware 1035 of UE 1030 further includes processing circuitry 1038, which may comprise one or more programmable processors, application-specific integrated circuits, field programmable gate arrays or combinations of these (not shown) adapted to execute instructions. UE 1030 further comprises software 1031, which is stored in or accessible by UE 1030 and executable by processing circuitry 1038. Software 1031 includes client application 1032. Client application 1032 may be operable to provide a service to a human or non-human user via UE 1030, with the support of host computer 1010. In host computer 1010, an executing host application 1012 may communicate with the executing client application 1032 via OTT connection 1050 terminating at UE 1030 and host computer 1010. In providing the service to the user, client application 1032 may receive request data from host application 1012 and provide user data in response to the request data. OTT connection 1050 may transfer both the request data and the user data. Client application 1032 may interact with the user to generate the user data that it provides.

It is noted that host computer 1010, base station 1020 and UE 1030 illustrated in FIG. 10 may be similar or identical to host computer 930, one of base stations 912a, 912b, 912c and one of UEs 991, 992 of FIG. 9, respectively. This is to say, the inner workings of these entities may be as shown in FIG. 10 and independently, the surrounding network topology may be that of FIG. 9.

In FIG. 10, OTT connection 1050 has been drawn abstractly to illustrate the communication between host computer 1010 and UE 1030 via base station 1020, without explicit reference to any intermediary devices and the precise routing of messages via these devices. Network infrastructure may determine the routing, which it may be configured to hide from UE 1030 or from the service provider operating host computer 1010, or both. While OTT connection 1050 is active, the network infrastructure may further take decisions by which it dynamically changes the routing (e.g., on the basis of load balancing consideration or reconfiguration of the network).

Wireless connection 1070 between UE 1030 and base station 1020 is in accordance with the teachings of the embodiments described throughout this disclosure. One or more of the various embodiments improve the performance of OTT services provided to UE 1030 using OTT connection 1050, in which wireless connection 1070 forms the last segment. More precisely, the teachings of these embodiments may improve the handover reliability and thereby provide benefits such as improved user experience.

A measurement procedure may be provided for the purpose of monitoring data rate, latency and other factors on which the one or more embodiments improve. There may further be an optional network functionality for reconfiguring OTT connection 1050 between host computer 1010 and UE 1030, in response to variations in the measurement results. The measurement procedure and/or the network functionality for reconfiguring OTT connection 1050 may be implemented in software 1011 and hardware 1015 of host computer 1010 or in software 1031 and hardware 1035 of UE 1030, or both. In embodiments, sensors (not shown) may be deployed in or in association with communication devices through which OTT connection 1050 passes; the sensors may participate in the measurement procedure by supplying values of the monitored quantities exemplified above, or supplying values of other physical quantities from which software 1011, 1031 may compute or estimate the monitored quantities. The reconfiguring of OTT connection 1050 may include message format, retransmission settings, preferred routing etc.; the reconfiguring need not affect base station 1020, and it may be unknown or imperceptible to base station 1020. Such procedures and functionalities may be known and practiced in the art. In certain embodiments, measurements may involve proprietary UE signaling facilitating host computer 1010's measurements of throughput, propagation times, latency and the like. The measurements may be implemented in that software 1011 and 1031 causes messages to be transmitted, in particular empty or ‘dummy’ messages, using OTT connection 1050 while it monitors propagation times, errors etc.

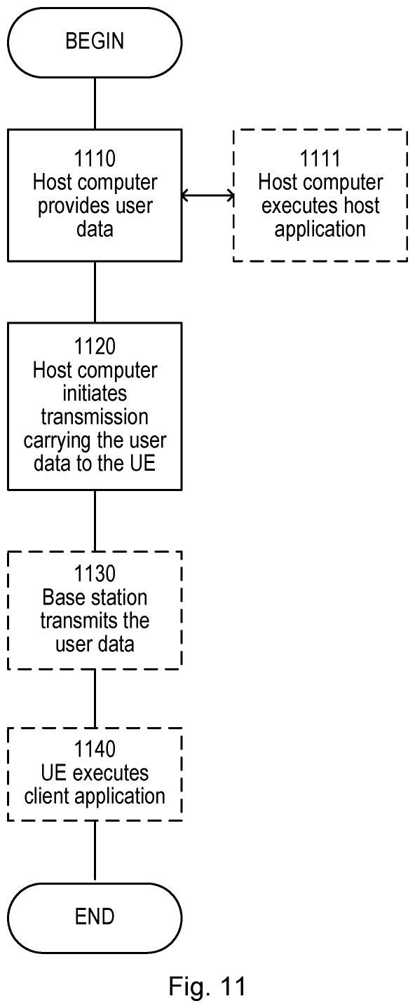

11FIG. 11 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 11 will be included in this section. In step 1110, the host computer provides user data. In substep 1111 (which may be optional) of step 1110, the host computer provides the user data by executing a host application. In step 1120, the host computer initiates a transmission carrying the user data to the UE. In step 1130 (which may be optional), the base station transmits to the UE the user data which was carried in the transmission that the host computer initiated, in accordance with the teachings of the embodiments described throughout this disclosure. In step 1140 (which may also be optional), the UE executes a client application associated with the host application executed by the host computer.

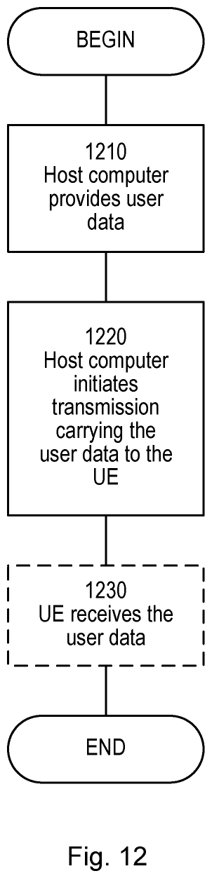

12FIG. 12 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 12 will be included in this section. In step 1210 of the method, the host computer provides user data. In an optional substep (not shown) the host computer provides the user data by executing a host application. In step 1220, the host computer initiates a transmission carrying the user data to the UE. The transmission may pass via the base station, in accordance with the teachings of the embodiments described throughout this disclosure. In step 1230 (which may be optional), the UE receives the user data carried in the transmission.

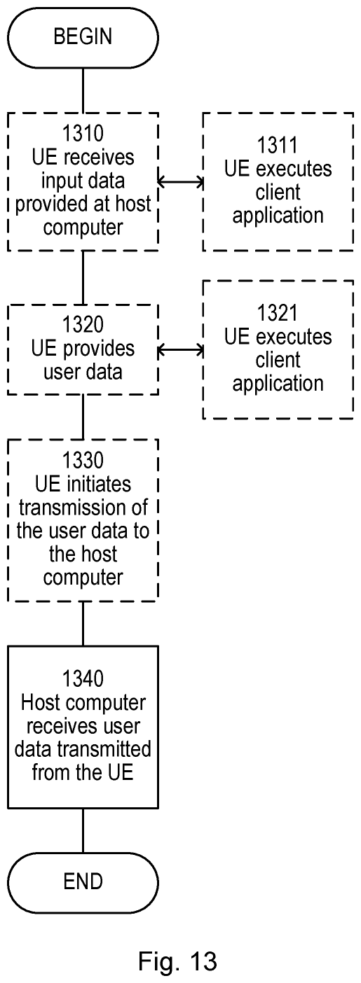

13FIG. 13 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 13 will be included in this section. In step 1310 (which may be optional), the UE receives input data provided by the host computer. Additionally or alternatively, in step 1320, the UE provides user data. In substep 1321 (which may be optional) of step 1320, the UE provides the user data by executing a client application. In substep 1311 (which may be optional) of step 1310, the UE executes a client application which provides the user data in reaction to the received input data provided by the host computer. In providing the user data, the executed client application may further consider user input received from the user. Regardless of the specific manner in which the user data was provided, the UE initiates, in substep 1330 (which may be optional), transmission of the user data to the host computer. In step 1340 of the method, the host computer receives the user data transmitted from the UE, in accordance with the teachings of the embodiments described throughout this disclosure.

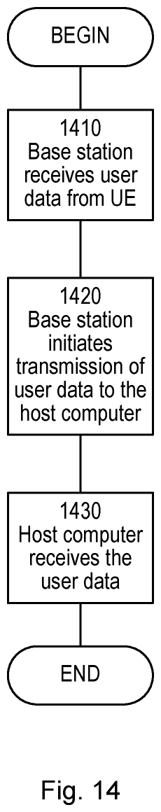

14FIG. 14 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 14 will be included in this section. In step 1410 (which may be optional), in accordance with the teachings of the embodiments described throughout this disclosure, the base station receives user data from the UE. In step 1420 (which may be optional), the base station initiates transmission of the received user data to the host computer. In step 1430 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

15FIG. 15 illustrates a schematic block diagram of an apparatus 1500 in a wireless network (for example, the wireless network shown in FIG. 6). The apparatus may be implemented in a wireless device or network node (e.g., wireless device 610 or network node 660 shown in FIG. 6). Apparatus 1500 is operable to carry out the example method described with reference to FIG. 3 and possibly any other processes or methods disclosed herein. It is also to be understood that the method of FIG. 3 is not necessarily carried out solely by apparatus 1500. At least some operations of the method can be performed by one or more other entities.

Virtual Apparatus 1500 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause transmitting unit 1502 and any other suitable units of apparatus 1500 to perform corresponding functions according one or more embodiments of the present disclosure.

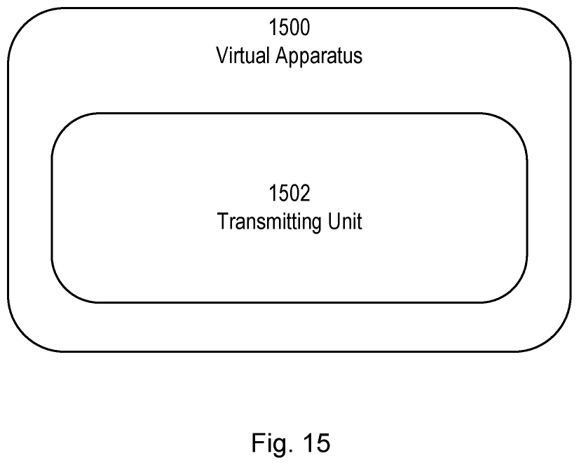

As illustrated in FIG. 15, apparatus 1500 includes transmitting unit 1502. Transmitting unit 1502 is configured to responsive to detection of a radio link failure or a Secondary Cell Group, SCG, failure after a successful handover, transmit an indication of a handover type of the successful handover to the base station.

16FIG. 16 illustrates a schematic block diagram of an apparatus 1600 in a wireless network (for example, the wireless network shown in FIG. 6). The apparatus may be implemented in a wireless device or network node (e.g., wireless device 610 or network node 660 shown in FIG. 6). Apparatus 1600 is operable to carry out the example method described with reference to FIG. 4 and possibly any other processes or methods disclosed herein. It is also to be understood that the method of FIG. 4 is not necessarily carried out solely by apparatus 1600. At least some operations of the method can be performed by one or more other entities.

Virtual Apparatus 1600 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause transmitting unit 1602 and any other suitable units of apparatus 1600 to perform corresponding functions according one or more embodiments of the present disclosure.

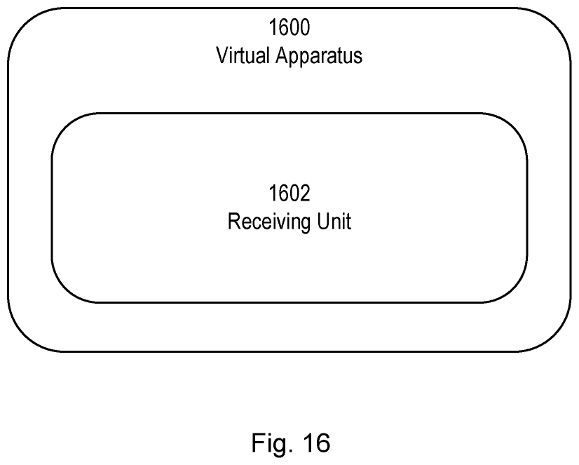

As illustrated in FIG. 16, apparatus 1600 includes receiving unit 1602. Receiving unit 1602 is configured to responsive to a radio link failure or a Secondary Cell Group, SCG, failure occurring after a successful handover of a wireless device, receive an indication of a handover type of the successful handover.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

The following numbered statements provide additional information on aspects of embodiments:
1. A method performed by a wireless device for reporting handover related information to a base station for mobility parameter optimization, the method comprising:
   responsive to detection of a radio link failure or a Secondary Cell Group, SCG,
   failure after a successful handover, transmitting an indication of a handover type of
   the successful handover to the base station.
2. The method of statement 1 wherein the handover type comprises one or more of: a legacy handover, a conditional handover, a conditional handover combined with a Dual Active Protocol Stack, DAPS, handover, or a DAPS handover.
3. The method of statement 2 further comprising, responsive to the successful handover being a conditional handover or a conditional handover combined with a DAPS handover, logging an indication of whether a re-establishment cell selected after the radio link failure was a candidate cell for the successful handover in an radio link failure (RLF) report, and transmitting the RLF report to the base station.
4. The method of statement 2 further comprising, responsive to the successful handover being a conditional handover or a conditional handover combined with a DAPS handover, logging an indication of whether an indication of whether a reconnect cell identification was a candidate cell for the successful handover in a radio link failure report, and transmitting the RLF report to the base station.
5. The method of statement 1 wherein the successful handover comprises a Primary Secondary Cell, PSCell, change in a dual connectivity scenario.
6. The method of statement 5 wherein the handover type comprises one of:
   a. a normal SCG change, a conditional SCG change, a conditional PSCell change, a conditional SCG change combined with a DAPS handover, or a DAPS SCG change.
7. The method of statement 6 further comprising, responsive to the successful handover being one of: a conditional SCG change, a conditional PSCell change, a conditional SCG change combined with a DAPS handover, or a DAPS SCG change, logging an indication of whether a cell selected after the radio link failure was a candidate cell for the successful handover in a radio link failure report, and transmitting the radio link failure report to the base station.
8. The method of statement 6 further comprising, responsive to the successful handover being one of: a conditional SCG change, a conditional PSCell change, a conditional SCG change combined with a DAPS handover, or a DAPS SCG change, logging an indication of whether a reconnect cell identification identifies a candidate cell for the successful handover in a radio link failure report, and transmitting the radio link failure report to the base station.
9. The method of any of the previous statements further comprising logging the handover type in a radio link failure report and transmitting the radio link failure report to the base station.
10. The method of any of the previous statements, further comprising:
   providing user data; and
   forwarding the user data to a host computer via the transmission to the base station.
11. A method performed by a base station for receiving handover related information for mobility parameter optimization, the method comprising:
   responsive to a radio link failure or a Secondary Cell Group, SCG, failure occurring after a successful handover of a wireless device, receiving an indication of a handover type of the successful handover.
12. The method of statement 11 wherein the handover type comprises one or more of: a legacy handover, a conditional handover, a conditional handover combined with a DAPS handover, or a DAPS handover.
13. The method of statement 11 or 12 further comprising: responsive to receiving the indication of the handover type, adjusting parameters associated with the handover type.
14. The method of statement 12 or 13 further comprising, responsive to the successful handover being a conditional handover or a conditional handover combined with a DAPS handover, receiving, in a radio link failure report, an indication of whether a re-establishment cell selected after the radio link failure was a candidate cell for the successful handover.
15. The method of statement 14 further comprising: responsive to the re-establishment cell not being a candidate cell for the successful handover, adding the re-establishment cell to a list of candidate cells for conditional handover.
16. The method of statement 12 or 13 further comprising, responsive to the successful handover being a conditional handover or a conditional handover combined with a DAPS handover, receiving, in a radio link failure report, an indication of whether a reconnect cell identification was a candidate cell for the successful handover.
17. The method of statement 16 further comprising: responsive to the reconnect cell identification not being a candidate cell for the successful handover, adding the reconnect cell identification to a list of candidate cells for conditional handover.
18. The method of statement 11 wherein the successful handover comprises a Primary Secondary Cell, PSCell, change in a dual connectivity scenario.
19. The method of statement 18 wherein the handover type comprises one or more of:
   a. a normal SCG change, a conditional SCG change, a conditional PSCell change, a conditional SCG change combined with a DAPS handover, or a DAPS SCG change.
20. The method of statement 18 further comprising, responsive to the successful handover being one of: a conditional SCG change, a conditional PSCell change, a conditional SCG change combined with a DAPS handover, or a DAPS SCG change, receiving, in a radio link failure report, an indication of whether a cell selected after the radio link failure was a candidate cell for the successful handover.
21. The method of statement 20 further comprising: responsive to the cell selected after the radio link failure not being a candidate cell for the successful handover, adding the cell selected after the radio link failure to a list of candidate cells for conditional handover.
22. The method of statement 18 further comprising, responsive to the successful handover being one of: a conditional SCG change, a conditional PSCell change, a conditional SCG change combined with a DAPS handover, or a DAPS SCG change, receiving, in a radio link failure report, an indication of whether a reconnect cell identification identifies a candidate cell for the successful handover.
23. The method of statement 22 further comprising: responsive to the reconnect cell identification not being a candidate cell for the successful handover, adding the reconnect cell identification to a list of candidate cells for conditional handover.
24. The method of any one of statements 11 to 23 wherein the indication of a handover type is received as part of a radio link failure report.
25. The method of any of statements 11 to 24, further comprising:
   obtaining user data; and
   forwarding the user data to a host computer or a wireless device.
26. A wireless device for transmitting handover related information for mobility parameter optimization, the wireless device comprising:
   processing circuitry configured to perform any of the steps of any of statements 1 to 10; and
   power supply circuitry configured to supply power to the wireless device.
27. A base station for receiving handover related information for mobility parameter optimization, the base station comprising:
   processing circuitry configured to perform any of the steps of any of statements 11 to 25;
   power supply circuitry configured to supply power to the base station.
28. A user equipment (UE) for transmitting handover related information for mobility parameter optimization, the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of statements 1 to 10;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
29. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of statements 11 to 25.
30. The communication system of statement 29 further including the base station.
31. The communication system of statement 29 or 30, further including the UE, wherein the UE is configured to communicate with the base station.
32. The communication system of any of statements 29 to 31, wherein:
   the processing circuitry of the host computer is configured to execute a host application, thereby providing the user data; and
   the UE comprises processing circuitry configured to execute a client application associated with the host application.
33. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of statements 11 to 25.
34. The method of statement 33, further comprising, at the base station, transmitting the user data.
35. The method of statement 33 or 34, wherein the user data is provided at the host computer by executing a host application, the method further comprising, at the UE, executing a client application associated with the host application.
36. A user equipment (UE) configured to communicate with a base station, the UE comprising a radio interface and processing circuitry configured to perform the methods of any of statements 33 to 35.
37. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of statements 1 to 10.
38. The communication system of statement 37, wherein the cellular network further includes a base station configured to communicate with the UE.
39. The communication system of statement 37 or 38, wherein:
   the processing circuitry of the host computer is configured to execute a host application, thereby providing the user data; and
   the UE's processing circuitry is configured to execute a client application associated with the host application.
40. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of statements 1 to 10.
41. The method of statement 40, further comprising at the UE, receiving the user data from the base station.
42. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of statements 1 to 10.
43. The communication system of statement 42, further including the UE.
44. The communication system of statement 42 or 43, further including the base station, wherein the base station comprises a radio interface configured to communicate with the UE and a communication interface configured to forward to the host computer the user data carried by a transmission from the UE to the base station.
45. The communication system of any of statements 42 to 44, wherein:
   the processing circuitry of the host computer is configured to execute a host application; and
   the UE's processing circuitry is configured to execute a client application associated with the host application, thereby providing the user data.
46. The communication system of any of statements 42 to 45, wherein:
   the processing circuitry of the host computer is configured to execute a host application, thereby providing request data; and
   the UE's processing circuitry is configured to execute a client application associated with the host application, thereby providing the user data in response to the request data.
47. A method implemented in a communication system including a host computer, a base station and a user equipment (UE), the method comprising:
   at the host computer, receiving user data transmitted to the base station from the UE, wherein the UE performs any of the steps of any of statements 1 to 10.
48. The method of statement 47, further comprising, at the UE, providing the user data to the base station.
49. The method of statement 47 or 48, further comprising:
   at the UE, executing a client application, thereby providing the user data to be transmitted; and
   at the host computer, executing a host application associated with the client application.
50. The method of any of statements 47 to 49, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
51. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of statements 11 to 25.
52. The communication system of statement 51 further including the base station.
53. The communication system of statement 51 or 52, further including the UE, wherein the UE is configured to communicate with the base station.
54. The communication system of any of statements 51 to 53, wherein:
   the processing circuitry of the host computer is configured to execute a host application;
   the UE is configured to execute a client application associated with the host application, thereby providing the user data to be received by the host computer.
55. A method implemented in a communication system including a host computer, a base station and a user equipment (UE), the method comprising:
   at the host computer, receiving, from the base station, user data originating from a transmission which the base station has received from the UE, wherein the UE performs any of the steps of any of statements 1 to 10.
56. The method of statement 55, further comprising at the base station, receiving the user data from the UE.
57. The method of statement 55 or 56, further comprising at the base station, initiating a transmission of the received user data to the host computer.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).
1×RTT CDMA2000 1×Radio Transmission Technology
3GPP 3rd Generation Partnership Project
5G 5th Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
E-SMLC Evolved-Serving Mobile Location Centre
ECGI Evolved CGI
eNB E-UTRAN NodeB
ePDCCH enhanced Physical Downlink Control Channel
E-SMLC evolved Serving Mobile Location Center
E-UTRA Evolved UTRA
E-UTRAN Evolved UTRAN
FDD Frequency Division Duplex
FFS For Further Study
GERAN GSM EDGE Radio Access Network
gNB Base station in NR
GNSS Global Navigation Satellite System
GSM Global System for Mobile communication
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MBMS Multimedia Broadcast Multicast Services
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCH Synchronization Channel
SCell Secondary Cell
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
UMTS Universal Mobile Telecommunication System
USIM Universal Subscriber Identity Module
UTDOA Uplink Time Difference of Arrival
UTRA Universal Terrestrial Radio Access
UTRAN Universal Terrestrial Radio Access Network
WCDMA Wide CDMA
WLAN Wide Local Area Network

1-31. (canceled)

32. A method performed by a wireless device for reporting handover related information to a base station for mobility parameter optimization, the method comprising:
responsive to detection of a radio link failure or a Secondary Cell Group (SCG) failure after a successful handover, transmitting an indication of a handover type of the successful handover to the base station.

33. The method of claim 32, wherein the handover type comprises one or more of: a legacy handover, a conditional handover, a conditional handover combined with a Dual Active Protocol Stack (DAPS) handover, or a DAPS handover.

34. The method of claim 33, further comprising, responsive to the successful handover being a conditional handover or a conditional handover combined with a DAPS handover, logging an indication of whether a re-establishment cell selected after the radio link failure was a candidate cell for the successful handover in a radio link failure (RLF) report; and transmitting the RLF report to the base station.

35. The method of claim 33, further comprising, responsive to the successful handover being a conditional handover or a conditional handover combined with a DAPS handover, logging an indication of whether a reconnect cell identification identifies a candidate cell for the successful handover in a radio link failure report, and transmitting the RLF report to the base station.

36. The method of claim 32, wherein the successful handover comprises a Primary Secondary Cell (PSCell) change in a dual connectivity scenario.

37. The method of claim 36, wherein the handover type comprises one of:
a normal SCG change, a conditional SCG change, a conditional PSCell change, a conditional SCG change combined with a DAPS handover, or a DAPS SCG change.

38. The method of claim 37, further comprising, responsive to the successful handover being one of: a conditional SCG change, a conditional PSCell change, a conditional SCG change combined with a DAPS handover, or a DAPS SCG change, logging an indication of whether a cell selected after the radio link failure was a candidate cell for the successful handover in a radio link failure report, and transmitting the radio link failure report to the base station.

39. The method of claim 37, further comprising, responsive to the successful handover being one of:
a conditional SCG change, a conditional PSCell change, a conditional SCG change combined with a DAPS handover, or a DAPS SCG change, logging an indication of whether a reconnect cell identification identifies a candidate cell for the successful handover in a radio link failure report, and transmitting the radio link failure report to the base station.

40. The method of claim 32, further comprising logging the handover type in a radio link failure report and transmitting the radio link failure report to the base station.

41. A method performed by a base station for receiving handover related information for mobility parameter optimization, the method comprising:
responsive to a radio link failure or a Secondary Cell Group (SCG) failure occurring after a successful handover of a wireless device, receiving an indication of a handover type of the successful handover.

42. The method of claim 41, further comprising: responsive to receiving the indication of the handover type, adjusting parameters associated with the handover type.

43. The method of claim 41, wherein the handover type comprises one or more of: a legacy handover, a conditional handover, a conditional handover combined with a DAPS handover, or a DAPS handover.

44. The method of claim 43, further comprising, responsive to the successful handover being a conditional handover or a conditional handover combined with a DAPS handover, receiving, in a radio link failure report, an indication of whether a re-establishment cell selected after the radio link failure was a candidate cell for the successful handover.

45. The method of claim 44, further comprising: responsive to the re-establishment cell not being a candidate cell for the successful handover, adding the re-establishment cell to a list of candidate cells for a conditional handover.

46. The method of claim 43, further comprising, responsive to the successful handover being a conditional handover or a conditional handover combined with a DAPS handover, receiving, in a radio link failure report, an indication of whether a reconnect cell identification identifies a candidate cell for the successful handover.

47. The method of claim 46, further comprising: responsive to the reconnect cell identification not identifying a candidate cell for the successful handover, adding the identified reconnect cell to a list of candidate cells for a conditional handover.

48. The method of claim 41, wherein the successful handover comprises a Primary Secondary Cell (PSCell) change in a dual connectivity scenario.

49. The method of claim 48, wherein the handover type comprises one or more of:
a normal SCG change, a conditional SCG change, a conditional PSCell change, a conditional SCG change combined with a DAPS handover, or a DAPS SCG change.

50. The method of claim 48, further comprising, responsive to the successful handover being one of: a conditional SCG change, a conditional PSCell change, a conditional SCG change combined with a DAPS handover, or a DAPS SCG change, receiving, in a radio link failure report, an indication of whether a cell selected after the radio link failure was a candidate cell for the successful handover.

51. The method of claim 50, further comprising: responsive to the cell selected after the radio link failure not being a candidate cell for the successful handover, adding the cell selected after the radio link failure to a list of candidate cells for a conditional handover.

52. The method of claim 48, further comprising, responsive to the successful handover being one of: a conditional SCG change, a conditional PSCell change, a conditional SCG change combined with a DAPS handover, or a DAPS SCG change, receiving, in a radio link failure report, an indication of whether a reconnect cell identification identifies a candidate cell for the successful handover.

53. The method of claim 52, further comprising: responsive to the reconnect cell identification not identifying a candidate cell for the successful handover, adding the identified reconnect cell to a list of candidate cells for conditional handover.

54. The method of claim 41, wherein the indication of a handover type is received as part of a radio link failure report.

55. A wireless device for transmitting handover related information for mobility parameter optimization, the wireless device comprising:
processing circuitry configured to: responsive to detection of a radio link failure or a Secondary Cell Group (SCG) failure after a successful handover, transmit an indication of a handover type of the successful handover to a base station; and
power supply circuitry configured to supply power to the wireless device.

56. A base station for receiving handover related information for mobility parameter optimization, the base station comprising:
processing circuitry configured to: responsive to a radio link failure or a Secondary Cell Group (SCG) failure occurring after a successful handover of a wireless device, receive an indication of a handover type of the successful handover; and
power supply circuitry configured to supply power to the base station.
